(19) United States
(12) Patent Application Publication
(10) Pub. No.: US 2026/0366989 A1
(43) Pub. Date: Nov. 19, 2026

(54) MICROVOLUME CUVETTE FOR SPECTROPHOTOMETRIC AND FLUOROMETRIC ANALYSIS

(71) Applicant: David Zhang Lei, Mansfield Center, CT (US)

(72) Inventor: David Zhang Lei, Mansfield Center, CT (US)

(21) Appl. No.: 19/731,013

(22) Filed: Jul. 4, 2026

Related U.S. Application Data
(60) Provisional application No. 63/885,214, filed on Sep. 20, 2025.

(51) Int. Cl. G01N 21/05; G01N 21/03; G01N 21/64

(52) U.S. Cl. CPC G01N 21/05; G01N 21/645; G01N 2021/0346; G01N 2021/0389; G01N 2021/054; G01N 2021/6482

(57) ABSTRACT

A microvolume cuvette for optical analysis is disclosed. The cuvette includes a body configured to interface with a spectrophotometer cuvette holder. In one embodiment, the body is L-shaped and formed of an opaque material, featuring an internal channel defining an optical path length. The internal channel is dimensioned to draw and retain a sample fluid via capillary action. In a fluorometric embodiment, the body comprises a block featuring at least two intersecting, orthogonal chambers, including an excitation channel and an emission channel configured to align collinearly along the optical axis of an incident light source and a fluorescence detector, respectively. The intersection of the orthogonal chambers defines an internal cavity configured to receive a sample fluid. The cuvette body may comprise a multi-piece assembly and may include light-transmissive plates coplanar to the emission and detector faces to inhibit sample evaporation.

### CROSS-REFERENCE TO RELATED APPLICATIONS:

This application claims the benefit of U.S. Provisional Application No. 63/885,214, filed on Sep. 20, 2025.

### FIELD OF THE INVENTION

This disclosure relates generally to analytical optical instrumentation and, more particularly, to microvolume cuvettes configured for spectrophotometric and fluorometric analysis.

### SUMMARY

The present disclosure describes a cuvette designed for use in spectrophotometric analysis, specifically optimized for low-volume samples. The cuvette utilizes inherent capillary action and surface tension properties to retain a liquid volume ranging from sub-microliter (e.g., 0.25 microliter) to tens of microliters. It features a defined optical path length, and the cuvette is sized to be compatible with standard cuvette holders (e.g., 12.5 mm×12.5 mm×45 mm). Additionally, the cuvette can be manufactured using injection molding. An alternative embodiment of the cuvette allows for microvolume fluorescence spectrophotometric analysis.

### BACKGROUND

Ultraviolet-Visible, or UV-Vis, spectrophotometry is a widely used technique in analytical chemistry and molecular biology for the quantitative analysis of biological samples such as nucleic acids, proteins, and small molecules, based on absorption in the ultraviolet (UV) and visible (Vis) spectrum. This technique relies on the principle that molecules absorb light at specific wavelengths corresponding to electronic transitions, allowing for the determination of concentration, purity, and other chemical properties. In conventional laboratory workflows, UV-Vis measurements are typically performed using cuvettes with a fixed path length of 10 mm, requiring sample volumes in the range of 1.0-3.5 milliliters (mL) or more to ensure sufficient optical coverage between the instrument's source and detector. However, in many modern applications, such as DNA/RNA quantification, rare protein analysis, drug screenings, or enzyme assays, researchers must work with minimal sample volumes, often in the microliter (μL) or sub-microliter range. The standard cuvette design creates a bottleneck in the efficient and accurate processing of small-volume samples in otherwise highly sensitive workflows.

This limitation becomes pronounced in scenarios where sample availability is restricted due to the high costs of reagents or limited initial sample volumes. The requirement to dilute or pool samples solely to satisfy the minimum fluid volume thresholds of conventional cuvettes can lead to lower sensitivity, loss of precision, sample waste, or inaccurate measurements, especially when the target analyte is unstable or only available in trace quantities. Such constraints can be problematic in applications such as nanoparticle characterization or nucleic acid analysis, where accurate measurements are critical for downstream experiments or diagnostics. Consequently, there is a demand for a microvolume measurement device that can deliver reliable data while minimizing sample consumption.

Furthermore, in fluorescence spectroscopy, an adjacent field to UV-Vis, workflows are traditionally restricted to specialized, single-purpose instrumentation, which introduces capital cost constraints for standard laboratories. Accordingly, there is a demand for an advanced microvolume cuvette architecture that can facilitate data collection across both linear absorption and orthogonal fluorescence regimes. It is advantageous if such a device achieves these microvolume capabilities while remaining configured for high-volume fabrication at reduced unit costs, configured for single-use or reusable applications, and structurally compatible with standard spectrophotometers and fluorometers present in conventional laboratory environments.

Several standalone platforms have been developed to address the need for low-volume UV-Vis spectrophotometric analysis, yet many introduce technical and operational limitations. One prominent category utilizes open-air droplet-pedestal platforms or open-top microplate systems (such as those described in U.S. Pat. No. 8,142,734 or U.S. Patent Application Publication No. 2015/0253239A1), which rely on surface tension or hydrophobic boundaries to contain micro-samples between exposed optical surfaces. While capable of accommodating reduced volumes, these open-air configurations expose the sample directly to the environment, rendering it susceptible to rapid evaporation, concentration shifts, and environmental contamination. Furthermore, they typically mandate the purchase of dedicated instrumentation or specialized readers, making them incompatible with standard laboratory spectrophotometers. Similarly, integrated fluidic and solid-state biosensing technologies, such as inline fiber-optic probes, microfluidic chips (Lab-on-a-Chip), automated flow cells, and surface-confined sensors relying on surface plasmon resonance (SPR) techniques, require complex internal capillary channels or proprietary external coupling optics. These architectures can be difficult to clean, prone to cross-contamination, susceptible to data variances from fluidic micro-bubbles or non-specific binding, and may lack a defined, linear optical pathlength through a bulk sample volume.

Regarding existing alternative cuvettes engineered to be compatible with conventional spectrophotometer cuvette shafts, current models generally fall into two categories, each presenting distinct technical limitations: high-cost, multi-piece quartz assemblies or sealed, single-use capillary microcuvettes. High-precision quartz microcuvettes (such as pivot-arm or stoppered ultra-micro vessels) feature articulated moving parts, delicate coatings, or rigid structural boundaries that drive manufacturing complexity and increase unit costs, which can restrict disposability options. Conversely, molded plastic microcuvettes relying on closed, narrow, and structurally inaccessible internal fluidic paths can trap chemical residues, making thorough decontamination for multi-use applications challenging. Furthermore, some sealed capillary networks require a higher sample volume (typically several μL or greater) to completely prime internal microfluidic feed channels and fill the measurement cavity, rendering them inefficient for volume-limited or high-value biological analytes.

Accordingly, there remains an unmet need for a unibody, structurally minimalistic microvolume cuvette capable of performing ultra-low sample volume measurements down to a sub-microliter threshold within standard, unmodified laboratory optical instruments.

### BRIEF DESCRIPTION OF THE DRAWINGS

FIG. 1 is a front perspective view of one example of an L-shaped microvolume cuvette.

FIG. 2 is a top-down view of the L-shaped cuvette of FIG. 1.

FIG. 3 is a side view of an L-shaped cuvette of FIG. 1.

FIG. 4 is a side perspective view of an L-shaped cuvette of FIG. 1.

FIG. 5 is a side perspective view of an L-shaped cuvette of FIG. 1 with a beveled base and tapered chamber entry geometry.

FIG. 6 is a side view of one example of an L-shaped microvolume cuvette capable of attaching to a housing piece.

FIG. 7 is a side view of one example of a housing piece capable of attaching to an L-shaped microvolume cuvette.

FIG. 8 is a side perspective view of one example of an L-shaped microvolume cuvette next to a housing piece.

FIG. 9 is a front perspective view of the cuvette of FIG. 8.

FIG. 10 is a top-down view of the cuvette of FIG. 8.

FIG. 11 is a top-down view of an assembled L-shaped microvolume cuvette and housing piece.

FIG. 12 is a side perspective view of the cuvette of FIG. 11.

FIG. 13 is a side perspective view of an L-shaped microvolume cuvette with a rectangular chamber.

FIG. 14 is a side perspective view of an L-shaped microvolume cuvette with an enlarged circular chamber.

FIG. 15 is a side perspective view of a rigid scraper piece.

FIG. 16 is a side perspective view of an L-shaped microvolume cuvette with a removable chamber.

FIG. 17 is a front perspective view of the cuvette of FIG. 16.

FIG. 18 is a top-down view of the cuvette of FIG. 16.

FIG. 19 is a perspective view of the cuvette of FIG. 16.

FIG. 20 is a front perspective view of an assembled L-shaped microvolume cuvette with a removable chamber.

FIG. 21 is a side perspective view of the cuvette of FIG. 20.

FIG. 22 is a top-down view of the cuvette of FIG. 20.

FIG. 23 is a top-down view of an assembled L-shaped microvolume cuvette and housing piece with filleted edges.

FIG. 24 is a side perspective view of the cuvette of FIG. 23.

FIG. 25 is a top-down view of an assembled L-shaped microvolume cuvette and housing piece that is thickened.

FIG. 26 is a side perspective view of an assembled L-shaped microvolume cuvette of FIG. 25.

FIG. 27 is a side perspective view of a disassembled L-shaped microvolume cuvette and housing piece that is thickened.

FIG. 28 is a perspective view of a dual-chambered microvolume cuvette.

FIG. 29 is a top-down view of a cuvette of FIG. 28.

FIG. 30 is a perspective view of an L-shaped microvolume cuvette with a thickened chamber face and chamber.

FIG. 31 is a front-facing view of the cuvette of FIG. 30.

FIG. 32 is a side perspective view of a rigid-block microvolume cuvette.

FIG. 33 is a side perspective view of a two-piece design microvolume cuvette.

FIG. 34 is a front perspective view of a two-piece design microvolume cuvette of FIG. 33.

FIG. 35 is a top-down view of the cuvette of FIG. 33.

FIG. 36 is a perspective view of an assembled two-piece design microvolume cuvette.

FIG. 37 is a perspective view of a two-piece design microvolume cuvette with an indent for a special plate.

FIG. 38 is a front perspective view of a two-piece design microvolume cuvette with an indent for a special plate.

FIG. 39 is a front perspective view of a two-piece design microvolume cuvette with an indent for a special plate, and a special plate.

FIG. 40 is a top-down view of the cuvette of FIG. 39.

FIG. 41 is a side-perspective view of a partially assembled special plate and a two-piece design microvolume cuvette with an indent for a special plate.

FIG. 42 is a side-perspective view of a double special plate design and a two-piece design microvolume cuvette with an indent for special plates.

FIG. 43 is a front perspective view of the cuvette of FIG. 42.

FIG. 44 is a front perspective view of a partially assembled double-chamber special plate and a two-piece design microvolume cuvette with an indent for special plates.

FIG. 45 is a side perspective view of a partially assembled two-piece design cuvette of FIG. 44.

FIG. 46 is a side view of the cuvette of FIG. 45.

FIG. 47 is a side perspective view of a microvolume cuvette comprised of a base, support beam, and chamber.

FIG. 48 is a top-down view of a microvolume cuvette of FIG. 47.

FIG. 49 is a front perspective view of a microvolume cuvette of FIG. 47.

FIG. 50 is a top-down view of a microvolume cuvette with a suspended chamber comprised of a base, two support beams, and a chamber.

FIG. 51 is a side perspective view of a microvolume cuvette of FIG. 50.

FIG. 52 is a perspective view of a microvolume cuvette of FIG. 50.

FIG. 53 is a spectral plot illustrating a representative ultraviolet-visible (UV-Vis) absorbance curve for a one-microliter (1 μL) sample volume of Bovine Serum Albumin (BSA) at a 1 mm optical path length, demonstrating an absorbance peak at 280 nm.

FIG. 54 is a spectral plot illustrating a representative absorbance curve for a one-microliter (1 μL) sample volume of 100 micromolar single-stranded DNA oligonucleotides, demonstrating measurement consistency with known reference standards.

FIG. 55 is a comparative graph overlaying the ultraviolet-visible (UV-Vis) absorbance spectra of a 40 nm gold nanoparticle (AuNP) solution as measured by the present cuvette versus a standard 1.5 mL, 1.0 cm pathlength cuvette, illustrating localized surface plasmon resonance (LSPR) alignment at 532 nanometers.

FIG. 56 is a spectral plot illustrating representative absorbance curves for 50 mg/L and 500 mg/L tartrazine dye solutions measured within the microvolume cuvette, demonstrating an absorption maximum at 427 nm and high-absorbance signal behavior.

FIG. 57 is a spectral plot illustrating a representative ultraviolet-visible (UV-Vis) absorbance curve for an ultra-low, 0.25 μL sample volume of Bovine Serum Albumin (BSA) utilizing a reduced chamber radius configuration (~0.4 mm), demonstrating sub-microliter sample analysis capabilities compatible with standard spectrophotometers.

FIG. 58 is a side view of a microvolume cuvette for fluorescence measurements formed from a single opaque block with circular chambers.

FIG. 59 is a perspective view of a microvolume cuvette of FIG. 58.

FIG. 60 is a perspective view of a microvolume cuvette for fluorescence measurements formed from a single, opaque block, with circular chambers and with physical chamber covers.

FIG. 61 is a perspective view of a microvolume cuvette for fluorescence measurements formed from a single, opaque block, with circular chambers and a chamfered base face.

FIG. 62 is a perspective view of a microvolume cuvette for fluorescence measurements formed from a single, opaque block, with rectangular-shaped chambers.

FIG. 63 is a perspective view of a microvolume cuvette for fluorescence measurements formed from a single, opaque block, with a smaller circular chamber.

FIG. 64 is a perspective view of a microvolume cuvette for fluorescence measurements formed from a single, opaque block, with a larger circular chamber.

FIG. 65 is a perspective view of a microvolume cuvette formed from a single, opaque block, with a 45-degree excitation/emission channel configuration.

FIG. 66 is a perspective view of a microvolume cuvette for fluorescence measurements formed from a single opaque block with two chambers symmetrically distal to the top and bottom faces.

FIG. 67 is a side view of a microvolume cuvette of FIG. 66.

FIG. 68 is a side view of a microvolume cuvette for fluorescence measurements formed from a single, opaque block, with a single circular chamber and with two lenses present on the emission and detector faces.

FIG. 69 is a side view of a microvolume cuvette formed from a single, opaque block, with a single circular chamber, that is shortened width-wise to accommodate different cuvette holders.

FIG. 70 is a side view of a microvolume cuvette for fluorescence measurements formed from a single opaque block with a single circular chamber, elongated width-wise to accommodate different cuvette holders.

FIG. 71 is a side view of a microvolume cuvette for fluorescence measurements formed from a single opaque block with a single circular chamber, with a portion of the emission face removed to reduce the path length.

FIG. 72 is a front view of a microvolume cuvette of FIG. 71.

FIG. 73 is a perspective view of a microvolume cuvette of FIG. 71.

FIG. 74 is a top-down view of a microvolume cuvette of FIG. 71.

FIG. 75 is a side view of an L-shaped microvolume cuvette with a geometric bubble trap.

FIG. 76 is a cross-sectional side view of an L-shaped microvolume cuvette of FIG. 75.

### DETAILED DESCRIPTION OF THE INVENTION

All terms used herein are intended to have their plain and ordinary meaning as understood by those skilled in the art, unless otherwise defined. The embodiments described are presented for illustrative purposes only and are not intended to limit the scope of the invention in any way.

As used herein, the singular forms “a,” “an,” and “the” are intended to include the plural forms as well, unless the context clearly indicates otherwise. The phrase “and/or” is used to indicate one or more of the listed items, individually or in combination.

The term “comprising” is intended to mean “inclusion without limitation” and is used in an open-ended sense and is not meant to constrain the invention. Similarly, the terms “includes,” “has,” and “containing” are used interchangeably and are not intended to exclude additional, unrecited elements or steps. “Consist” is to mean “exclusively” or “composed only of” in a closed-ended sense.

Where ranges are given, the endpoints are included; all values and subranges between the endpoints are also intended to be encompassed unless otherwise specified.

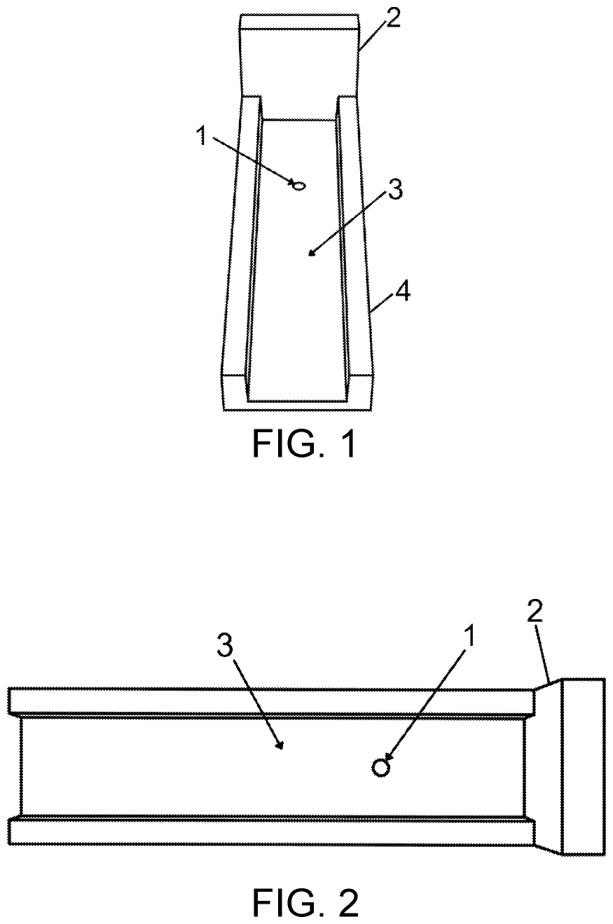

To avoid ambiguity, certain terms used herein are defined as follows:
1. The “chamber” or “chamber hole” refers to the round, rectangular, or other-shaped hole present on the cuvette. The chamber is to be positioned on the “chamber face,” that is, incident to the light source, in any location that both retains the sample and allows light to pass through. An example of a chamber is shown in FIG. 1.
2. In an embodiment designed specifically for fluorescence measurements, there are two distinct chambers. A first chamber is positioned on the “chamber face (51),” that is, incident to the light source and orthogonal to the detector, and is called the “excitation channel.” A second chamber is placed on the “detector face (53),” that is, parallel to the light beam received by the fluorescence detector, and is referred to as the “emission channel.” Overall, the two chambers are to be orthogonal to one another, forming a 90-degree angle at the intersection point. The “internal cavity” refers to the cavity formed by the two chamber holes.
3. The “chamber rim” refers to the outer perimeter rim present on a chamber. In the preferred embodiment, the chamber rim is at a sharp, unfilleted edge that forms a right angle with the chamber's interior wall.
4. The “channel” refers to the optical channel that forms a continuous tunnel through the cuvette body to guide light directly to the sample.
5. The “additional housing piece” refers to a detachable support object that provides lateral and roof support for the cuvette, which is configured to be compatible with some spectrophotometer models.
6. The “base” of the cuvette refers to the foundation of the cuvette that contacts the bottom of the cuvette holder in the spectrophotometer. An example of a base can be found in FIG. 1.
7. “Support beams” refer to the beam-like structures that may be used to suspend or position the chamber hole without restricting the surrounding area, unlike a fully filled-in chamber face would.

The present disclosure relates generally to a cuvette architecture configured to enable precise spectrophotometric and spectroscopic analysis using microvolume or ultra-low sample volumes while maintaining geometric compatibility with standard laboratory optical instruments, such as UV-Vis spectrophotometers and fluorometers. Embodiments described herein integrate features of standardized cuvettes with low-volume sample retention and variable optical pathlengths, ranging from sub-millimeter scales to tens of millimeters.

Referring to the drawings, in one embodiment, the cuvette comprises a passive, self-contained sample chamber (1) configured to define a controlled optical path length. The sample chamber (1) is configured to utilize surface tension and capillary action of a liquid sample to retain fluid volumes ranging from sub-microliter thresholds to tens of microliters within the optical pathlength. The cuvette body is dimensioned to interface directly with standard spectrophotometer sample holders (e.g., a 12.5 mm×12.5 mm×45 mm form factor holder) without requiring instrument modifications or external coupling optics. This configuration establishes a stable sample geometry that preserves measurement pathlength reproducibility while reducing the sample fluid consumption required for optical analysis.

In some embodiments, the cuvette configuration provides a repeatable sample fluid introduction profile. The sample chamber (1) may feature an open-top configuration configured for direct fluid loading via an external pipetting device. The sample chamber (1) is configured to receive fluid sample volumes ranging from approximately 0.25 microliters (μL) to approximately 50 μL. The geometric configuration of the cuvette body permits sample loading and subsequent optical measurement within the same structural orientation. The optical pathlength is defined by an axial thickness of the sample chamber (1) or may alternatively be determined based upon a known volume of the loaded fluid sample and a cross-sectional dimension of the sample chamber (1). In reusable applications, the sample chamber (1) is configured to be cleaned by flushing with a fluid solvent, dried utilizing a pressurized gas or an absorbent substrate, and subsequently reloaded. The cuvette is configured to define a variable optical path length that is dynamically determined by, and directly proportional to, the volume of the sample fluid introduced therein, such that an increase in sample volume establishes a correspondingly increased optical path length.

In one embodiment, the external geometry of the cuvette body is dimensioned to interface with conventional spectrophotometer sample receivers, such as a standard 12.5 mm×12.5 mm×45 mm cuvette holder form factor. The external dimensions enable insertion into pre-existing cuvette shafts without requiring auxiliary hardware adapters or instrument modifications. The cuvette body may be fabricated from a material comprising rigid polymers, quartz, glass, metals, or opaque materials such as polylactic acid (PLA) or aluminum, or any other structurally stable material configured to maintain dimensional tolerances under laboratory operating conditions.

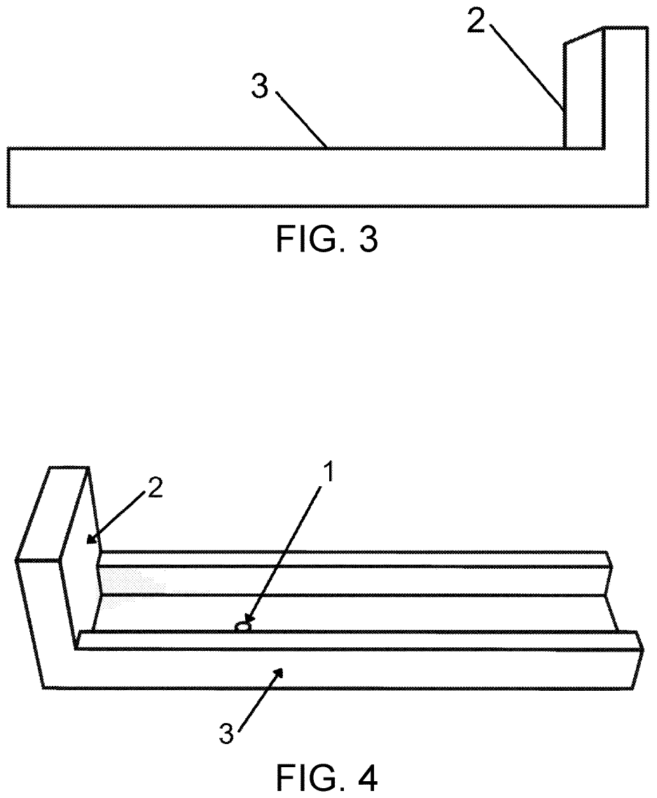

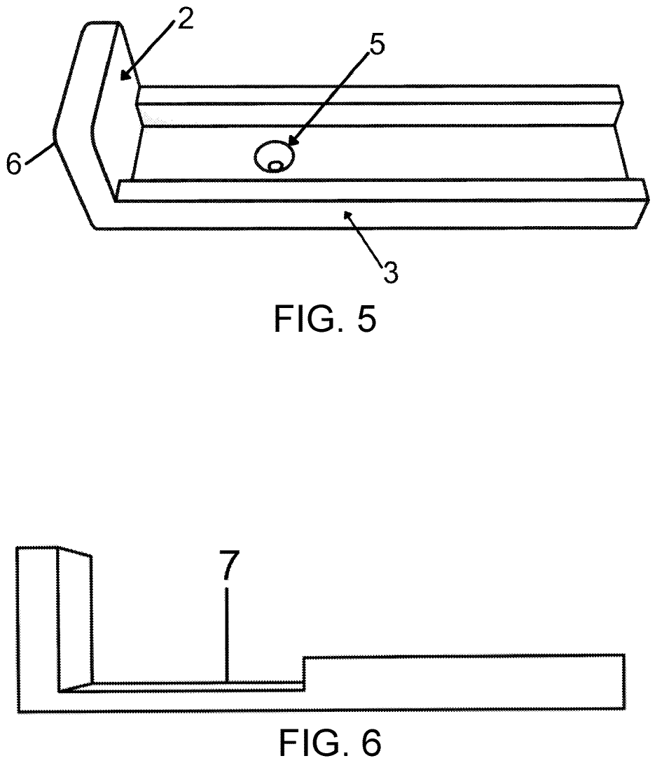

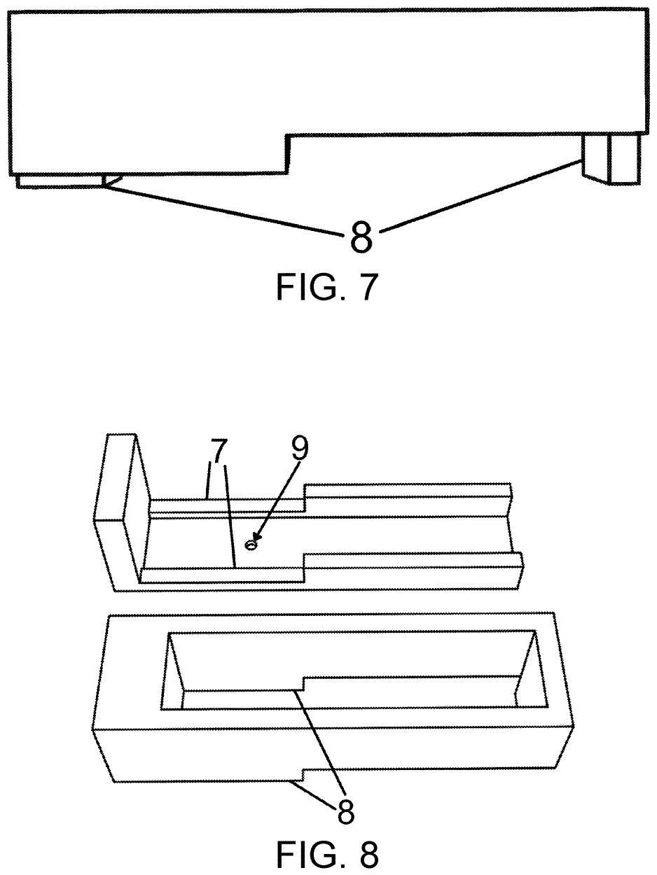

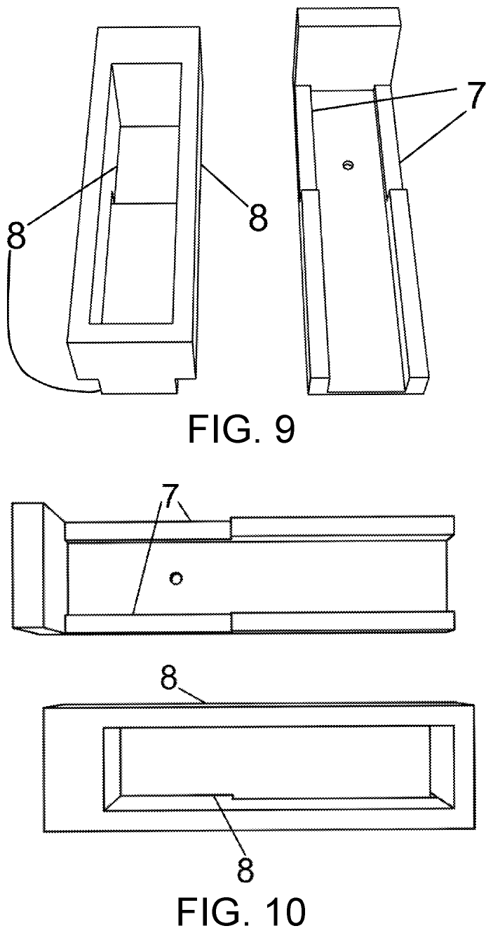

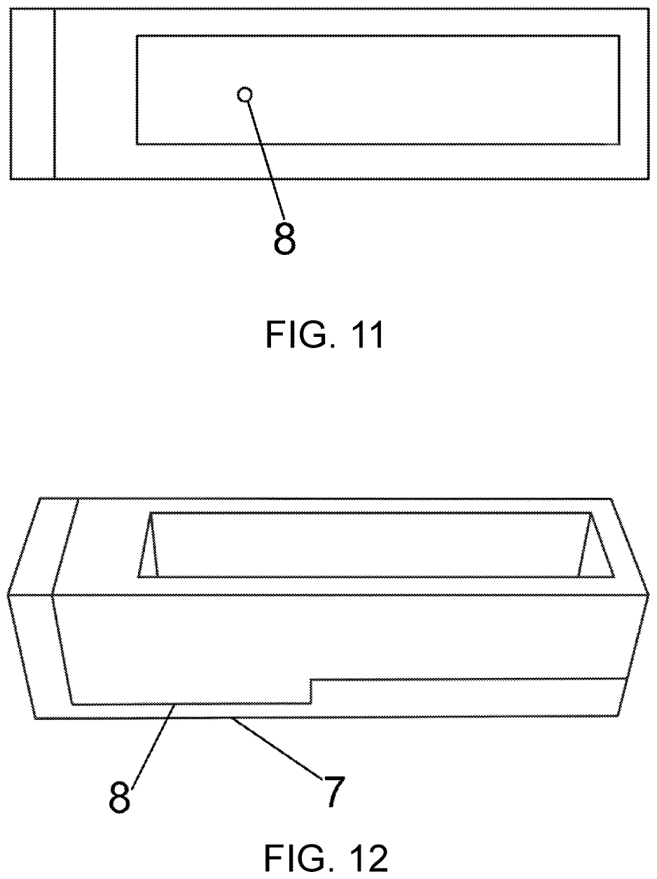

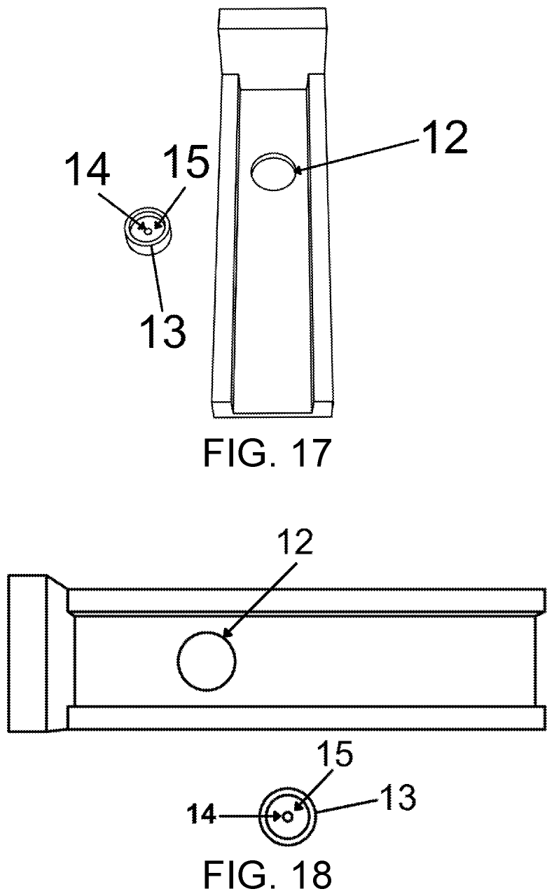

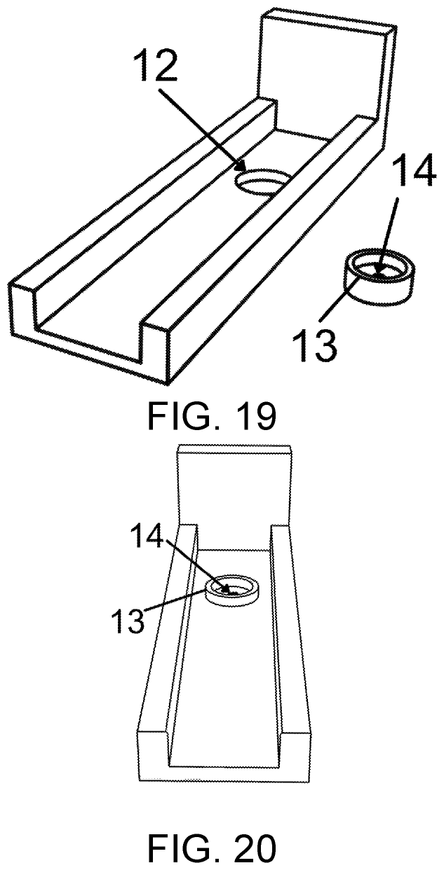

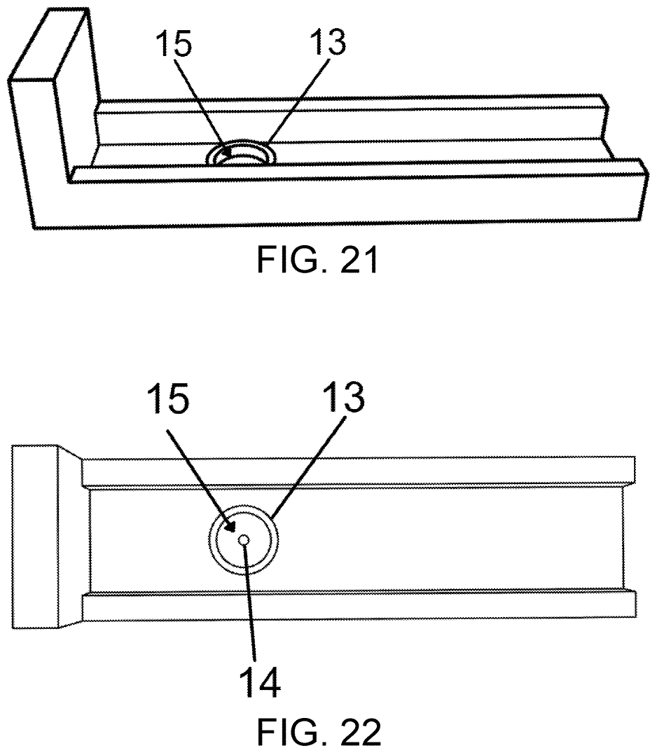

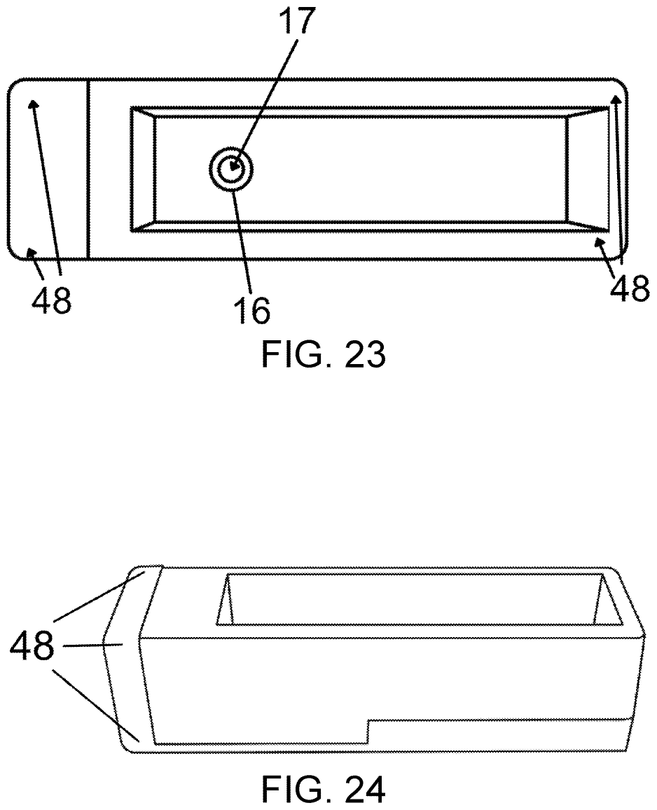

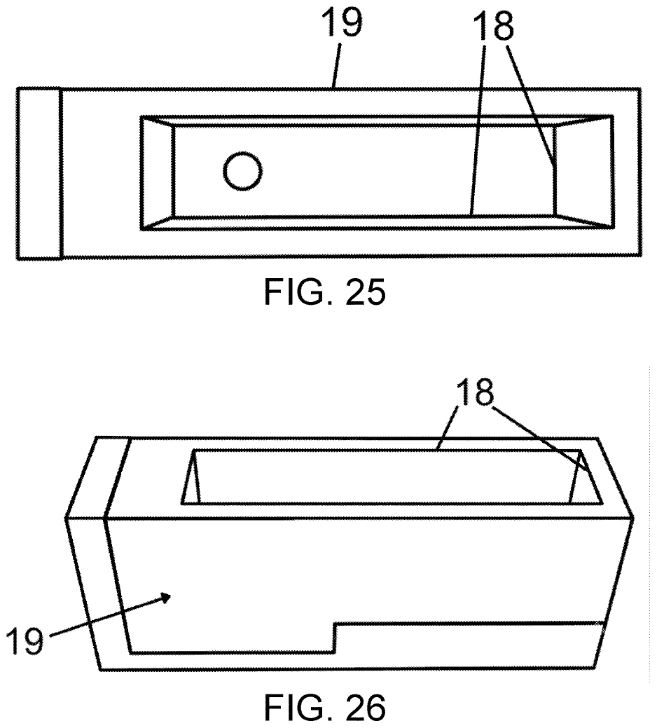

In one embodiment, the cuvette features an L-shaped configuration (comprising a base (2) and a lateral face (3), as illustrated in FIG. 3). A chamber hole (1) is disposed within the lateral face (3) and is dimensioned to retain the sample fluid, while being configured to align collinearly with an optical axis of emitted light for absorbance measurements. A side support (4) may be implemented to provide structural support to the lateral face. In another embodiment, an auxiliary housing component (FIG. 7) may be removably coupled to the cuvette body, configured to provide structural stability to the lateral sides and an upper portion of the cuvette body. This auxiliary housing component may be utilized to provide additional structural stabilization within certain spectrophotometer hardware configurations. The housing component may be reversibly coupled to the cuvette body via a magnetic engagement mechanism, an adhesive engagement mechanism, a snap-fit mechanism, or a friction-fit mechanism (7, 8). An assembled view of this configuration is illustrated in FIG. 12. In an alternative configuration of the L-shaped body, a removable chamber insert defining the chamber hole may be provided (as shown in FIG. 17), facilitating modification of the chamber dimensions within the same cuvette body. The chamber insert features a chamber hole (14) amidst a larger planar surface (15), contained in an assembly that can be removably coupled with the larger cuvette body (12). An assembled view of this configuration is illustrated in FIG. 22. Furthermore, the removable chamber insert may feature a tapered or filleted entry geometry (5) or raised perimeter edges (13) configured to facilitate sample fluid deposition (as illustrated in FIGS. 5 and 23, respectively).

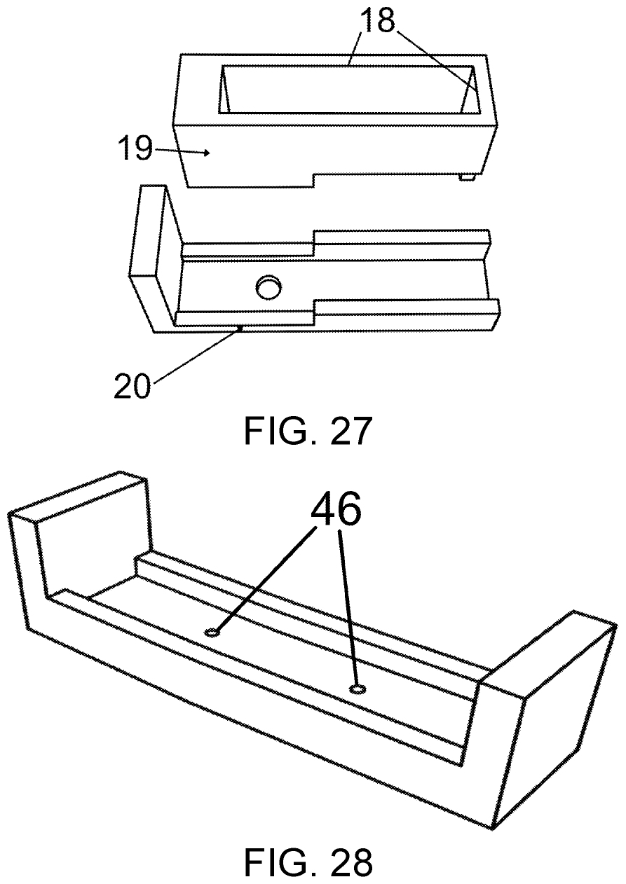

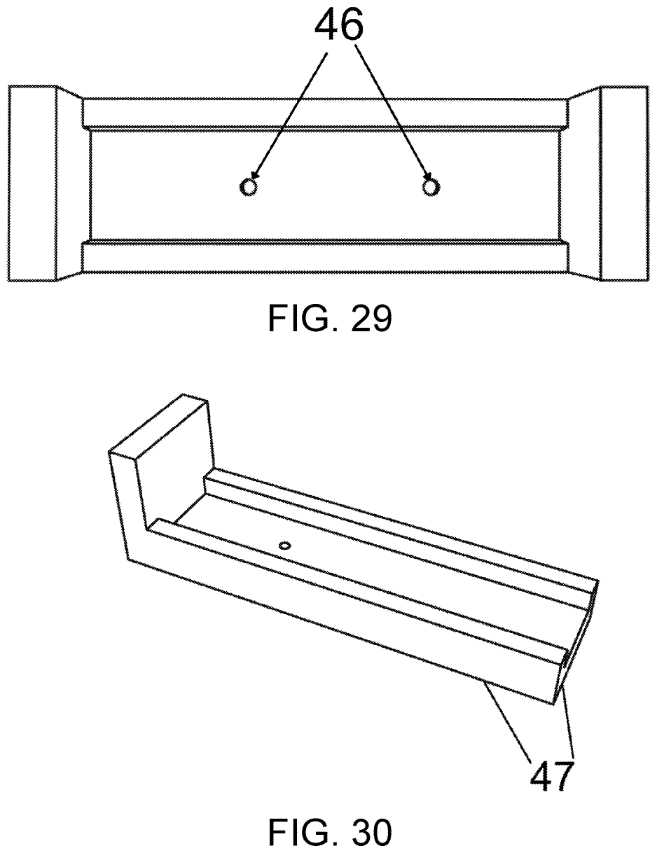

In other embodiments, the cuvette housing may feature alignment features such as keyed corners, tapered or filleted edges (6), or optical registration markings configured to facilitate repeatable insertion and optical beam alignment within spectrophotometer holders. In some embodiments, the housing and cuvette body may be configured to conform to alternative dimensions, such as a 5 mm×12.5 mm×45 mm form factor or a 17.5 mm×12.5 mm×45 mm form factor. Exemplary alternative thickness variants are illustrated in FIGS. 26 and 27.

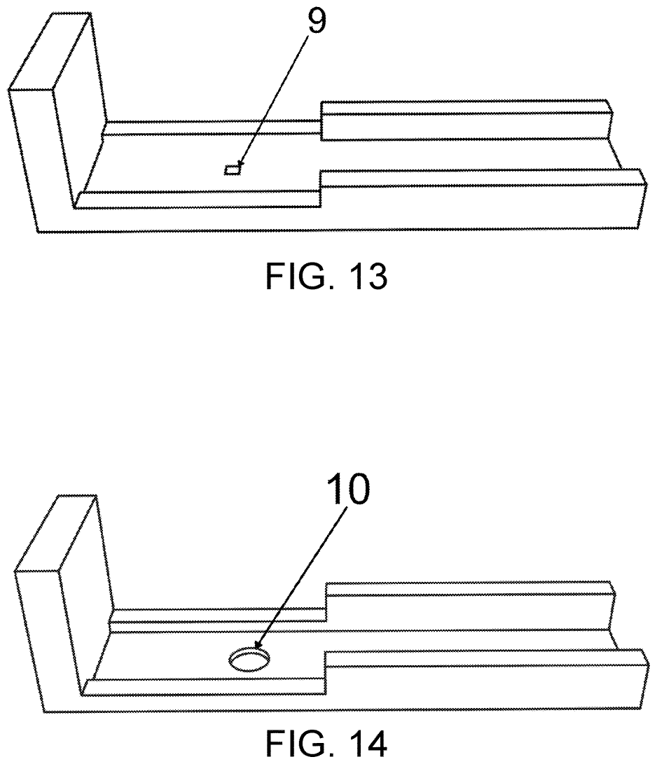

The cuvette body includes an internal sample chamber configured to retain a microvolume fluid sample within a defined optical measurement zone. In one embodiment, the sample chamber comprises a circular through-hole (1), a rectangular through-hole (9), or an alternative cross-sectional geometry configured to retain a fluid volume ranging from approximately 0.25 microliters (μL) to approximately 50 μL. An exemplary rectangular chamber configuration is illustrated in FIG. 13. The geometric configuration of the sample chamber is selected to confine the fluid sample within the optical measurement zone based upon the target sample volume variant.

Sample retention within the cuvette is achieved via passive fluidic mechanisms, utilizing the surface tension and capillary action properties of the fluid sample. In some embodiments, an internal surface of the sample chamber may feature surface treatments, such as a combination of hydrophilic and hydrophobic coatings, configured to modulate surface energy and promote fluid retention within the optical pathlength.

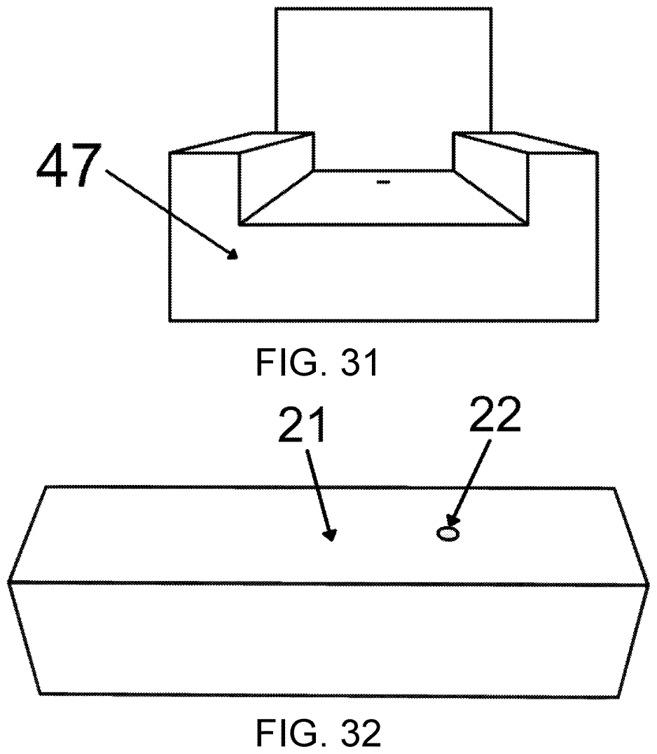

The depth and cross-sectional area of the chamber hole are dimensioned to define an optical path length through the fluid sample. In one configuration, the sample chamber features an axial depth of approximately 0.1 mm to 1.5 mm, establishing a pathlength for spectrophotometric absorbance measurements. In an alternative configuration, the sample chamber depth may range from approximately 1.5 mm to 12.5 mm, as illustrated in FIG. 31. Additionally, the sample chamber may feature a cross-sectional radius of approximately 0.05 mm to 3 mm to facilitate fluid retention across varying sample fluid volumes. An example of a larger chamber is found in FIG. 14.

Sample introduction may be performed manually or automatically via a fluid delivery device through the face of the cuvette body directly into the sample chamber. In some embodiments, the outer perimeter of the chamber rim includes a tapered or funnel-shaped entry geometry (5) configured to guide fluid sample deposition. Mechanical agitation may optionally be applied to facilitate fluid engagement within the sample chamber. Once positioned within the sample chamber, the fluid sample remains statically retained via capillary forces, permitting immediate optical measurement or subsequent analysis under controlled environmental conditions.

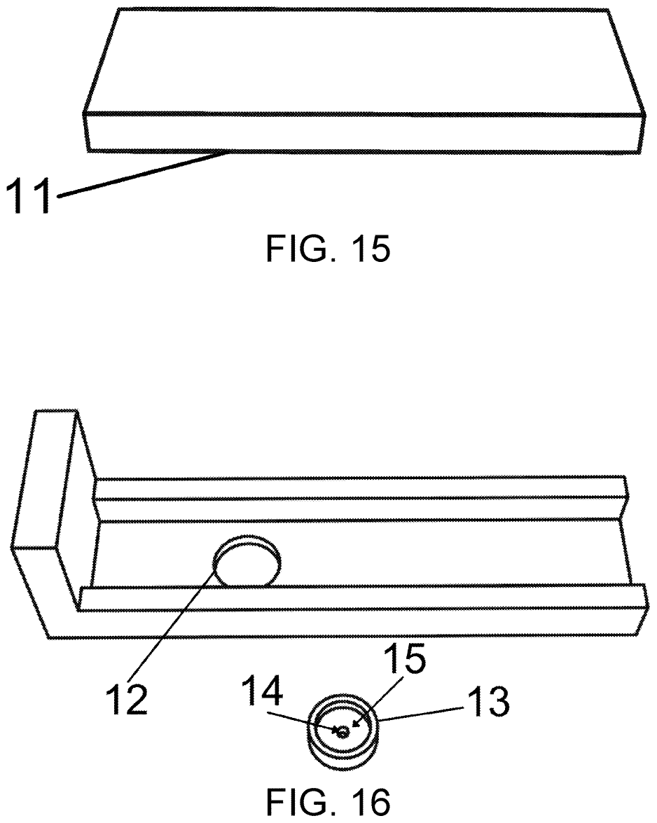

In the event of a sample fluid overfill, an excess volume of fluid may form a convex meniscus protruding past a plane of the chamber face. The planar configuration of the chamber face permits removal of the excess fluid volume utilizing an external planar edge or scraping tool, as illustrated in FIG. 15. This configuration enables geometric leveling of the fluid sample relative to the chamber face while mitigating unintended capillary drainage of the internal chamber volume via absorbent materials.

In some embodiments, the cuvette may incorporate two opposing, light-transmissive windows configured to enclose opposing openings of the sample chamber. These windows are fabricated from materials transmissive to ultraviolet and visible light, such as quartz, fused silica, or cyclic olefin copolymer, selected based upon target wavelength performance or manufacturing parameters. In one embodiment, internal and external surfaces of these windows are polished to an optical-grade flatness configured to minimize light scattering and promote uniform beam transmission. In another embodiment, a hydrophobic surface treatment may be applied to the windows to inhibit the adsorption of the fluid sample thereto.

In one embodiment, the cuvette incorporates an auxiliary housing (FIG. 7) constructed of a rigid, opaque material, such as polylactic acid (PLA) or acrylonitrile butadiene styrene (ABS), configured to substantially restrict light transmission to the path through the chamber hole and the fluid sample. This configuration minimizes stray light transmission to an optical detector by selectively directing the incident light beam through the retained fluid sample. In another embodiment, a lateral face containing the sample chamber is constructed from the opaque material, permitting alternative boundary surfaces defining the vertical or horizontal limits of the sample chamber to be formed from a light-transmissive material.

In one embodiment, the optical pathlength, or chamber depth, is defined by a fixed distance between opposing outer rims of the sample chamber and may range from approximately 0.1 mm to 1.5 mm. This geometry is configured to facilitate reproducible absolute and relative absorbance measurements during spectrophotometric analysis. The rigid pathlength configuration minimizes dimensional variability associated with fluid surface curvature, meniscus variations, or optical misalignment within the measurement zone.

To facilitate optical beam alignment, in some embodiments, the optical windows are arranged in substantially parallel planes and oriented substantially perpendicular to an incident light path upon insertion into a spectrophotometer holder. In other embodiments, integrated alignment features, such as molded alignment grooves or optical indexing marks, may be provided to enhance geometric reproducibility across distinct cuvette devices.

Furthermore, the cuvette body is configured to accommodate a wide range of spectrophotometric wavelengths, such as an optical spectrum spanning from approximately 200 nanometers (nm) to approximately 900 nm, or alternative wavelength ranges depending on the material composition of the cuvette body. Anti-reflective coatings may be applied to optical surfaces of the sample chamber to reduce Fresnel reflection losses, thereby optimizing optical transmission through the measurement zone.

Due to the microvolume scales of the fluid samples employed, evaporative sample loss may occur via ambient airflow or thermal energy generated by incident light when the sample chamber is exposed. Accordingly, fluid stabilization and evaporation control features may be integrated into the cuvette body to mitigate fluid loss. For example, in one embodiment, the sample chamber is recessed within the cuvette body, thereby restricting exposure to ambient airflow and minimizing the surface-area-to-volume ratio of the fluid sample. An evaporation shield or sealing film may be integrated with the cuvette body or provided as a removable accessory. This shield may comprise a thin, light-transmissive polymer film, such as polyethylene terephthalate (PET, for visible-range-only applications) or cyclic olefin copolymer, affixed over opposing openings of the sample chamber to mitigate evaporation effects while permitting optical transmission. The film may be disposable or reversibly attachable via a friction-fit mechanism, a snap-fit mechanism, a magnetic engagement mechanism, or an adhesive engagement mechanism. Alternatively, the cuvette may include a protective cap utilizing a snap-fit, magnetic, adhesive, friction-fit, or pressure-sealed engagement mechanism configured to enclose the sample chamber without intersecting the optical pathlength. In another embodiment, the cuvette body is formed as a structure featuring an integrated hinge-flip mechanism configured to permit selective folding and sealing of the sample chamber boundaries. A compressible silicone gasket may be disposed adjacent to the sample chamber to inhibit fluid leakage. In an alternative configuration, evaporation control is achieved by sealing opposing openings of the sample chamber with a layer of mineral oil or an alternative non-evaporable, substantially chemically inert fluid introduced via a fluid delivery device. This fluid layer establishes a physical barrier configured to inhibit evaporation of an aqueous fluid sample during optical measurement. The mineral oil or alternative fluid is light-transmissive and chemically inert relative to the fluid sample to minimize interference with optical absorbance signals. Mitigating evaporation via these structural configurations maintains sample spectral fidelity, enhances measurement reproducibility within microvolume spectrophotometric analysis, and facilitates kinetic or time-resolved spectral data collection.

Surface treatments may also be utilized to regulate sample fluid spreading and evaporation. For example, in some embodiments, an internal surface of the sample chamber is surface-coated or patterned to be hydrophilic, thereby promoting fluid localization within the sample chamber, while surrounding peripheral regions are surface-coated or patterned to be hydrophobic to confine the fluid volume and mitigate edge evaporation. In alternative embodiments, auxiliary barriers comprising wax materials or silicone formulations may be applied to minimize fluid sample loss over time during extended optical analysis intervals.

In one embodiment, the sample chamber is formed within predefined dimensional tolerances. For example, the manufacturing tolerances may be configured to maintain an internal optical path length as well as a chamber diameter uniformity within a variance of approximately ±0.01 mm, thereby facilitating device-to-device measurement reproducibility across distinct production batches. Materials configured to contact the fluid sample are selected for chemical and physical compatibility with target fluid analytes. Furthermore, the material selected for the cuvette body may feature light-masking or external masking properties configured to attenuate stray light transmission, thereby optimizing the optical signal-to-noise ratio during analysis.

In some embodiments, the cuvette body is fabricated utilizing microfabrication or molding techniques. For example, the cuvette body may be formed via injection molding from an opaque, rigid polymer such as acrylonitrile butadiene styrene (ABS) or polylactic acid (PLA), or an optically transparent thermoplastic such as cyclic olefin copolymer (COC) or transparent PMMA. The opaque polymer is light-masking to attenuate stray light transmission, thereby optimizing the optical signal-to-noise ratio. For configurations utilizing a light-transmissive polymer, a thin film or surface coating may be applied to a chamber face to substantially restrict stray light transmission, thereby serving as an aperture masking layer. Optional light-transmissive optical windows may be co-molded with, or separately manufactured and subsequently ultrasonically welded or solvent-bonded to, the cuvette body to promote fluid-tight integrity and optical clarity. Alternative fabrication methods include laser ablation, micromachining, or embossing. In some configurations, a snap-fit assembly may be incorporated, comprising a base featuring an integrated optical window or aperture and a lid or cap featuring a second window or aperture and an associated sealing element.

The cuvette may be configured for single-use (disposable) or multi-use (reusable) configurations depending upon the specific material properties and operational parameters. Single-use configurations may be sterilized or packaged for immediate waste disposal post-analysis. Multi-use configurations may feature structures configured to facilitate fluid evacuation and cleaning, such as removable caps or solvent-resistant chemical coatings. The auxiliary housing component may similarly be configured for single-use or multi-use operational requirements.

While certain embodiments may comprise an L-shaped cuvette body and a separate auxiliary housing component, numerous alternative configurations may be implemented in accordance with the principles of the present disclosure. The specific examples described herein are provided for illustrative purposes, and the structural configurations are adaptable to alternative geometric arrangements without departing from the scope of the disclosure.

In one embodiment, the cuvette comprises a dual-chamber configuration (46) featuring two discrete sample chambers configured to concurrently retain distinct fluid samples. An exemplary configuration is illustrated in FIG. 28. In this configuration, an upper horizontal surface of the cuvette body is configured to serve as a secondary base interface. Structurally, upon introducing fluid samples into both sample chambers, the cuvette body is configured to be positioned within a spectrophotometer to perform an optical measurement through the first sample chamber. The cuvette body is further configured to be removed from the spectrophotometer, rotated substantially 180 degrees, and reinserted, thereby positioning the second sample chamber within an optical path of the spectrophotometer. This configuration facilitates sequential or comparative optical analysis of multiple fluid sample volumes. The substantially symmetrical geometry of the cuvette body is configured to promote uniform optical path lengths and optical beam alignment across both sample chambers.

In an alternative embodiment, an axial depth or thickness of the chamber face wall may be increased to a dimension of approximately 1.0 mm to 12.5 mm (47) to vary the optical pathlength of the cuvette, as illustrated in FIG. 31. This configuration modifies the optical pathlength to modulate light absorbance across varying analyte concentrations. The adjusted chamber depth may be implemented while maintaining the external dimensions of the cuvette body, configured to maintain compatibility with a standard 12.5 mm×12.5 mm×45 mm spectrophotometer holder. Alternatively, the external dimensions may be adjusted to conform to specific spectrophotometer instrument dimensions. In such configurations, internal fluid volume capacities scale with the optical pathlength, and fluidic flow-guiding channels or capillary features may be integrated within the sample chamber to facilitate uniform fluid distribution throughout the elongated chamber volume.

In another embodiment, the cuvette body comprises a block of rigid material featuring a sample chamber (22) formed within a recessed portion of the block and the chamber face disposed substantially perpendicular to the incident light path. An exemplary configuration is illustrated in FIG. 32. In a related configuration, a second sample chamber may be symmetrically disposed within a superior portion of the cuvette body to facilitate concurrent or dual fluid sample loading.

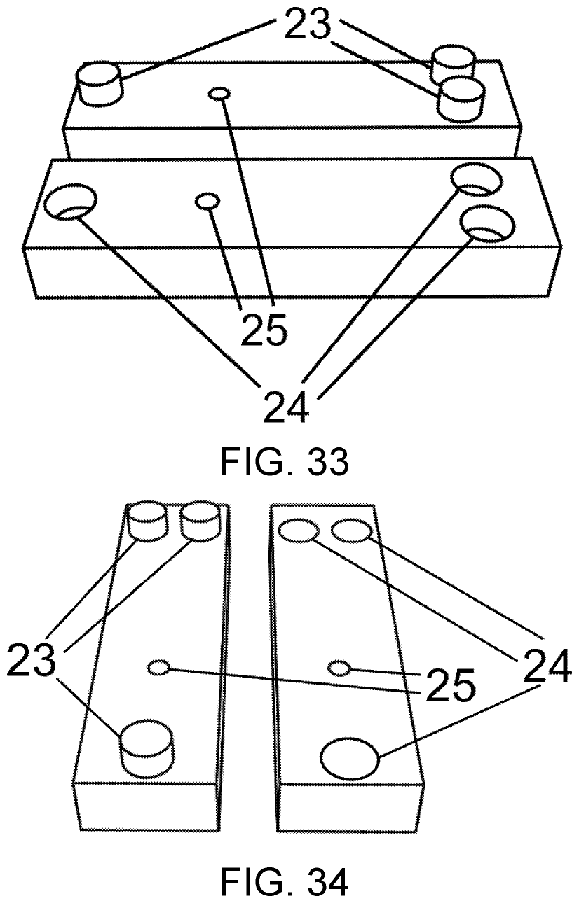

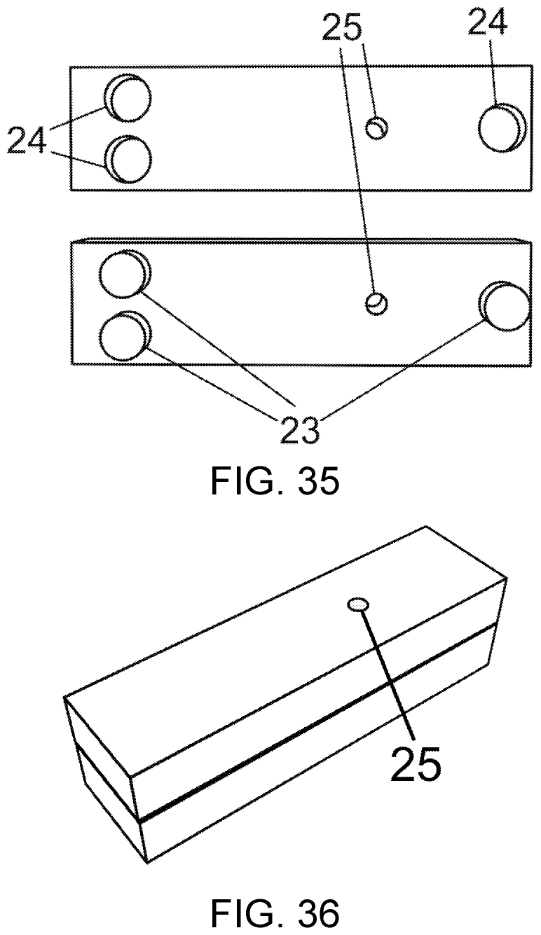

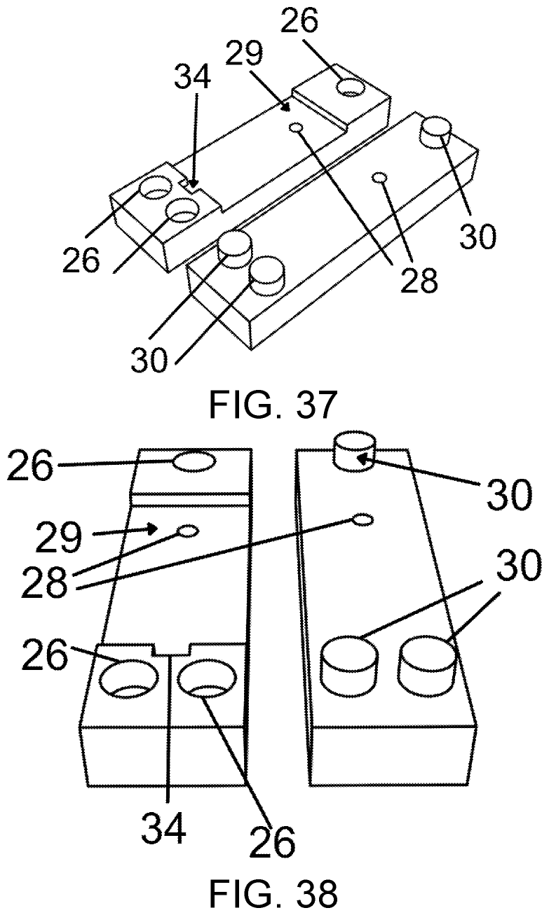

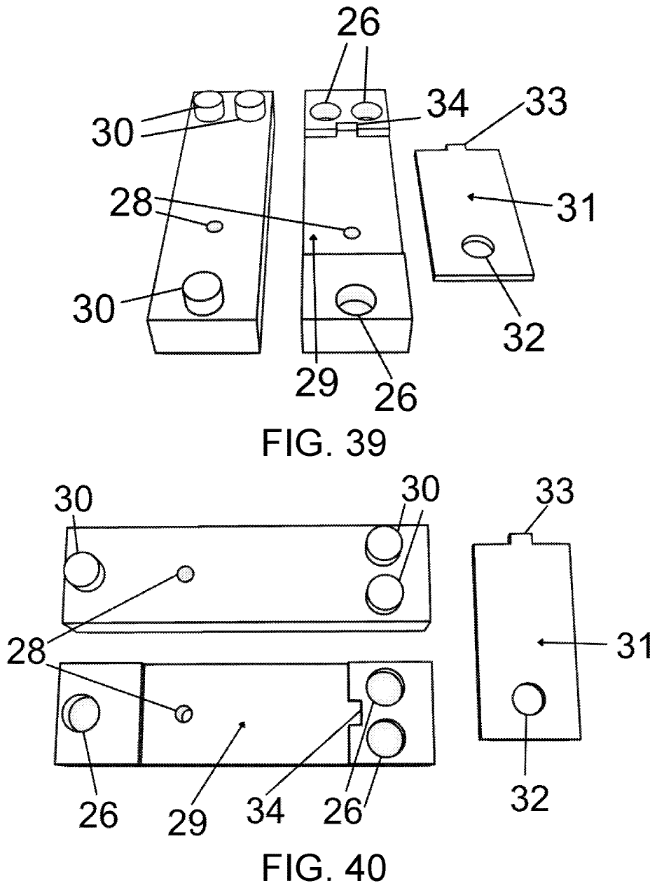

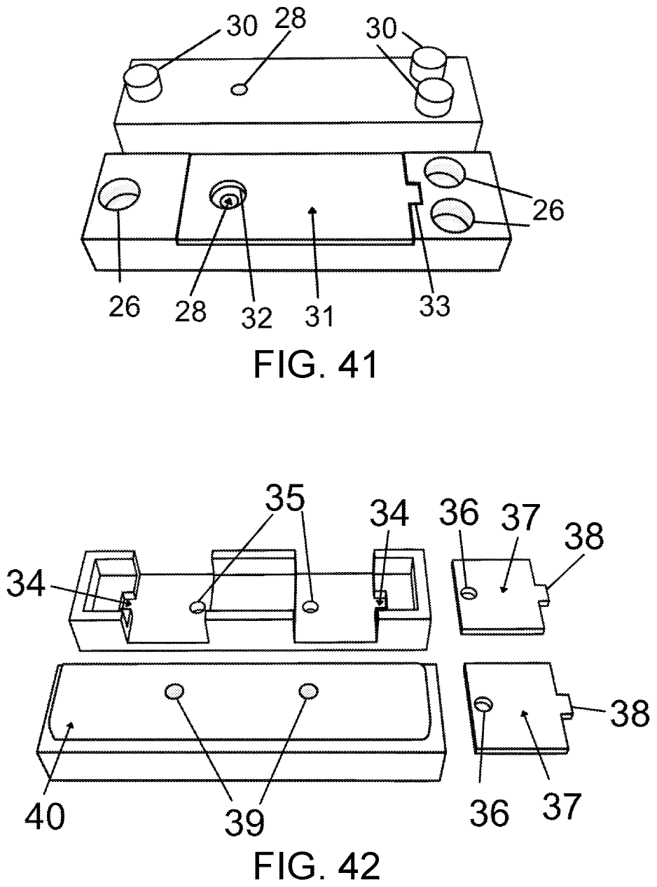

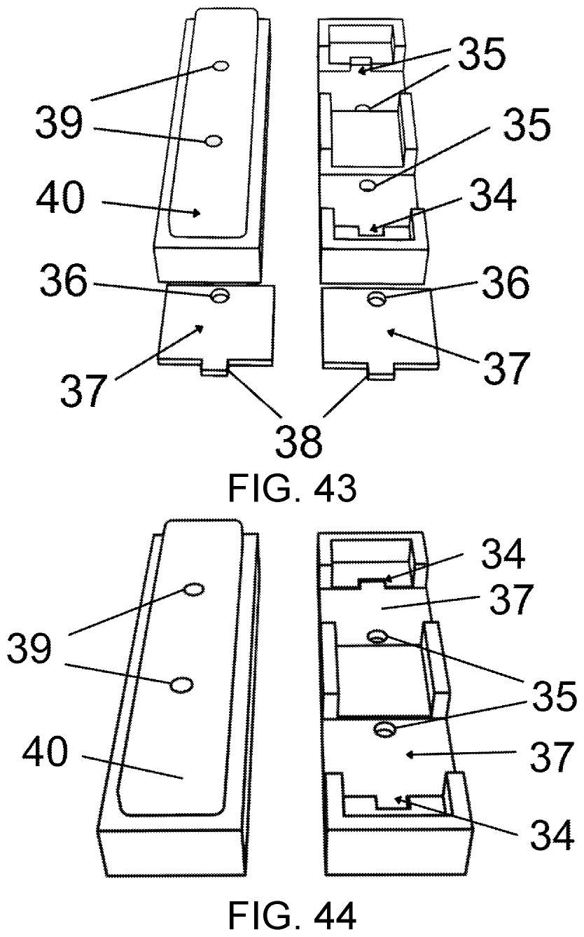

In an alternative embodiment, the cuvette body comprises a first mating body portion and a second mating body portion configured to selectively couple to form a unified cuvette assembly. An exemplary configuration is illustrated in FIG. 33. The two body portions may be removably coupled via an interference fit, a friction fit, a snap-fit mechanism, a magnetic engagement mechanism, or an adhesive interface. In one configuration, a friction-fit mechanism utilizing alignment pins (23) and corresponding apertures (24) selectively secures the two body portions together. Both body portions feature respective chamber holes (25) permitting fluid sample deposition within one or both chamber volumes. Upon assembly, the cuvette body is configured to maintain a substantially fluid-tight interface and optical clarity to facilitate optical absorbance or transmission measurements through the measurement zone. In an alternative configuration, an external surface of at least one body portion defines a recessed indentation (29) configured to provide manual or mechanical leverage to facilitate separation of the mated body portions. In another embodiment, sealing elements such as elastomeric gaskets or an adhesive sealant may be integrated along a contact interface of the body portions to inhibit fluid leakage. An assembled view of a cuvette operating in accordance with these configurations is illustrated in FIG. 36.

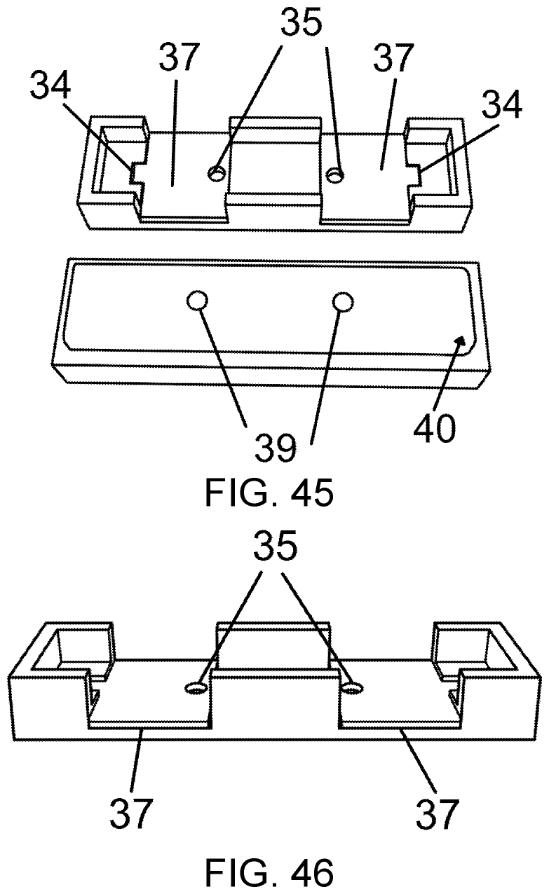

In an alternative configuration, an insert plate (31) having a thickness of approximately 0.3 mm to 1.4 mm may be positioned between the first and second body portions within a recessed indentation (29) possessing a corresponding depth of approximately 0.3 mm to 1.4 mm. The insert plate (31) defines a primary aperture configured to align with the sample chambers (28) to retain the fluid sample (32) therein. An alignment or retention interface (33, 34) may be provided to selectively secure the insert plate (31) within the cuvette assembly. A first light-transmissive layer, such as glass or quartz, may be disposed on a face of the insert plate (31) to inhibit fluid migration into adjacent components. A second light-transmissive layer may be disposed on an interior mating face of one of the body portions to bound the opposite side of the chamber volume and mitigate unintended fluid leakage. The insert plate (31) may be configured for reusable or single-use configurations. Upon joining the body portions, the cuvette assembly establishes a substantially fluid-tight seal and optical path to facilitate optical absorbance analysis while mitigating sample fluid evaporation. In a related configuration illustrated in FIG. 42, a dual-loading arrangement is provided wherein a secondary chamber aperture is defined within both the insert plate and the body portions. In this configuration, one or more insert plates (37) may be utilized, each defining a discrete chamber aperture (36) configured to align with corresponding apertures (35, 39) formed in the body portions. At least one body portion may feature a chamfered or filleted alignment edge (40) configured to facilitate geometric alignment during assembly. A partially assembled view of this multi-plate configuration is illustrated in FIG. 45.

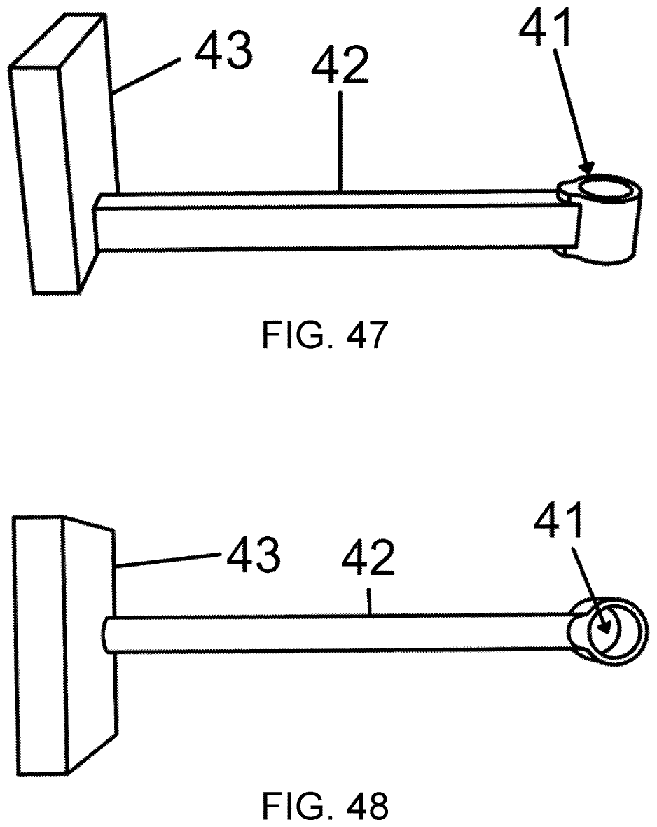

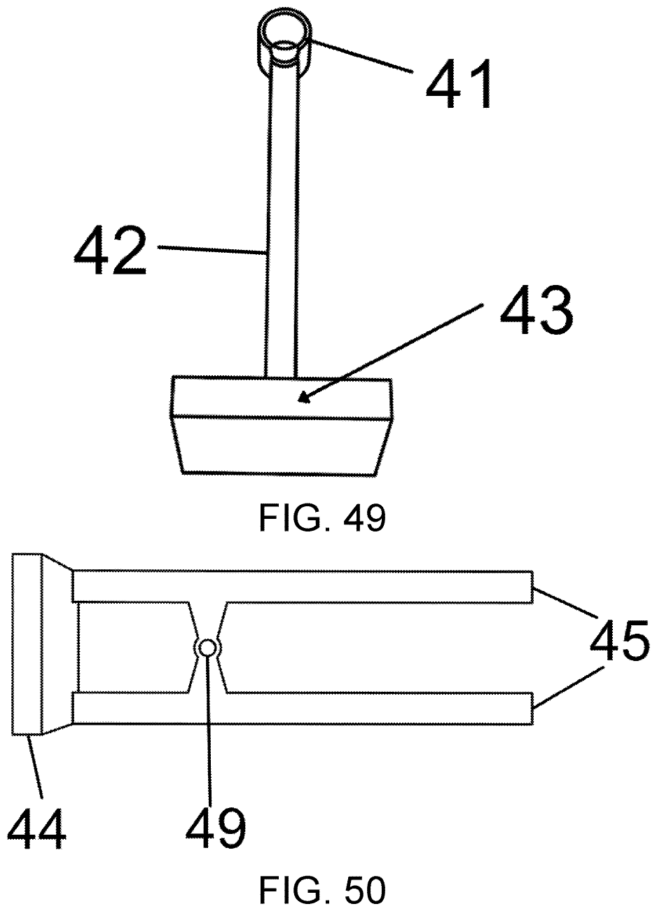

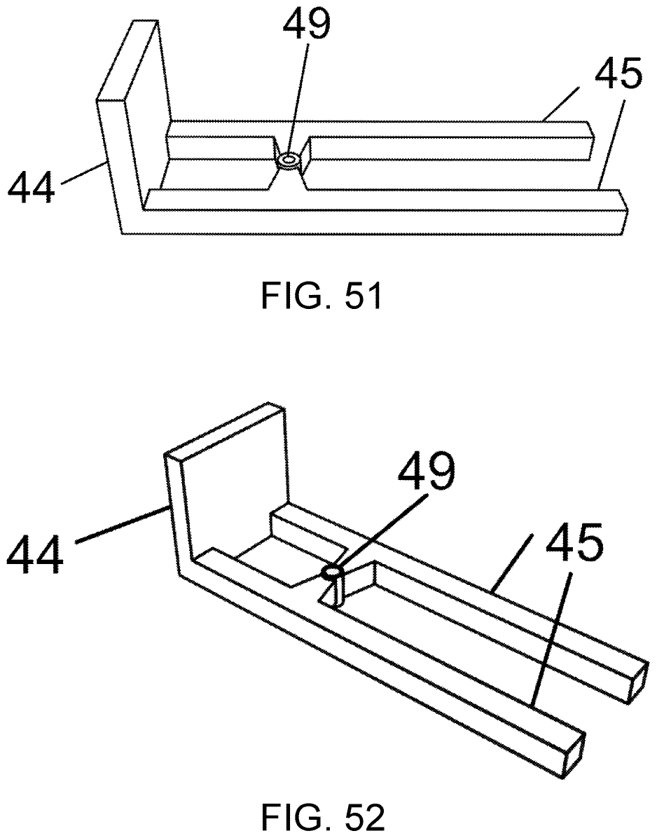

In another embodiment, the cuvette comprises a base (43) and an open-frame loop architecture defining a sample chamber (41) elevated above the base (43) by one or more elongated support beams (42), as illustrated in FIG. 47. The open-frame loop architecture is configured to be immersed directly into an external fluid volume to facilitate passive sampling via surface tension and capillary action within the boundaries of the sample chamber (41). An auxiliary fluid tray may be configured to hold a fluid sample and stabilize the cuvette base (43) during immersion, thereby promoting a uniform immersion depth and mitigating fluid spillage. In an alternative configuration shown in FIG. 52, a chamber hole (49) is vertically or horizontally suspended from a base (44) within the external perimeter boundaries of the cuvette by one or more auxiliary structural members (45). This configuration is configured to provide supplementary multi-axis structural stabilization within alternative spectrophotometer sample holder geometries to facilitate measurement reproducibility.

In an exemplary validation performance evaluation, experimental data were collected utilizing an extrusion-based additive manufacturing cuvette body formed from an opaque polylactic acid (PLA) polymer. The experimental cuvette body incorporated the structural configurations of the L-shaped body described herein, featuring a sample chamber with a cross-sectional radius of approximately 0.6 mm and an optical path length of approximately 1.0 mm. A conventional ultraviolet-visible (UV-Vis) spectrophotometer compatible with a standard 12.5 mm×12.5 mm×45 mm cuvette form factor was utilized for comparative analysis. The evaluation demonstrated functional compatibility with standard spectrophotometer optical configurations for microvolume fluid sample analysis. While the validation data herein was obtained using a 3D-printed prototype, one of ordinary skill in the art will appreciate that injection-molded embodiments are expected to perform comparably or better. Specifically, the superior surface finish and lack of layer lines inherent to injection molding further optimize the device's optical and fluidic consistency.

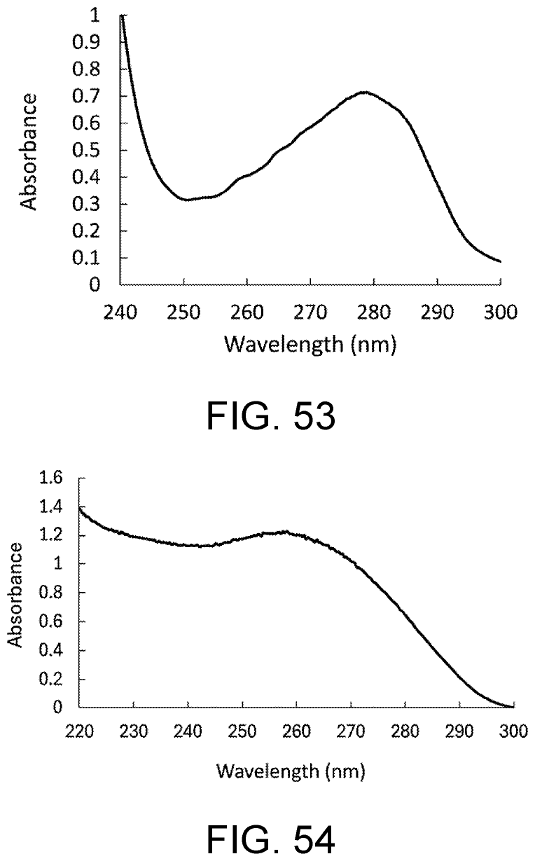

Characterization was performed utilizing a 10 mg/mL bovine serum albumin (BSA) aqueous solution. Upon introducing a fluid sample volume of approximately 1 microliter (μL) into the 1.0 mm optical pathlength sample chamber, spectrophotometric absorbance measurements were acquired across multiple analytical runs. A representative absorbance spectrum is illustrated in FIG. 53, demonstrating an absorbance maximum at a wavelength of approximately 280 nm, corresponding to the characteristic protein absorbance band.

Analytical evaluation was further conducted utilizing an approximately 1 microliter (μL) fluid sample volume of a 100 micromolar (μM) single-stranded deoxyribonucleic acid (ssDNA) oligonucleotide solution within the cuvette assembly. Spectrophotometric analysis yielded an absorbance spectrum illustrated in FIG. 54. The resultant absorbance curves demonstrated peak positions and absorbance magnitudes corresponding to characteristic oligonucleotide optical reference criteria.

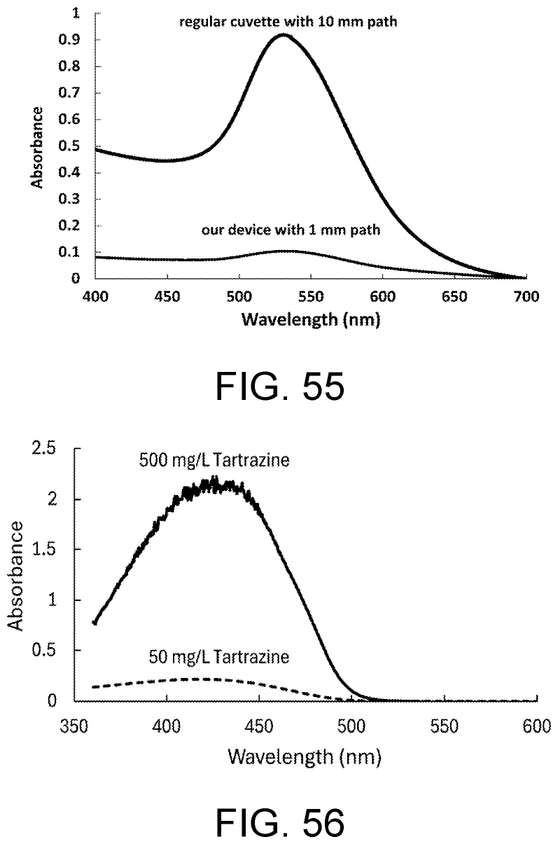

Aqueous solutions containing gold nanoparticles (AuNPs) featuring a nominal diameter of approximately 40 nm were evaluated utilizing the cuvette assembly and compared against a baseline measurement from a conventional 1.5 milliliter (mL) cuvette having a 1.0 cm optical pathlength, as illustrated in FIG. 55. The cuvette assembly generated absorbance spectra mapping to the localized surface plasmon resonance peak positions of the conventional reference cuvette. Due to the dimensional difference between the approximately 1.0 mm pathlength of the cuvette assembly and the 1.0 cm pathlength of the conventional cuvette, the measured peak absorbance values demonstrated a proportional linear attenuation corresponding to the reduction in optical pathlength. As shown in FIG. 55, both the cuvette assembly and the conventional cuvette configurations identified an absorption maximum at a wavelength of approximately 532 nm.

Tartrazine dye solutions at concentrations of 500 mg/L and 50 mg/L were evaluated utilizing the cuvette assembly. The cuvette assembly generated spectral measurements corresponding to the reference absorption spectrum for tartrazine, identifying an absorption maximum at a wavelength of approximately 427 nm. The resulting representative spectrum is illustrated in FIG. 56. Low-amplitude spectral noise was observed near the peak absorbance of approximately 2.25 absorbance units (AU) for the 500 mg/L sample configuration, consistent with signal-to-noise attenuation at elevated absorbance thresholds.

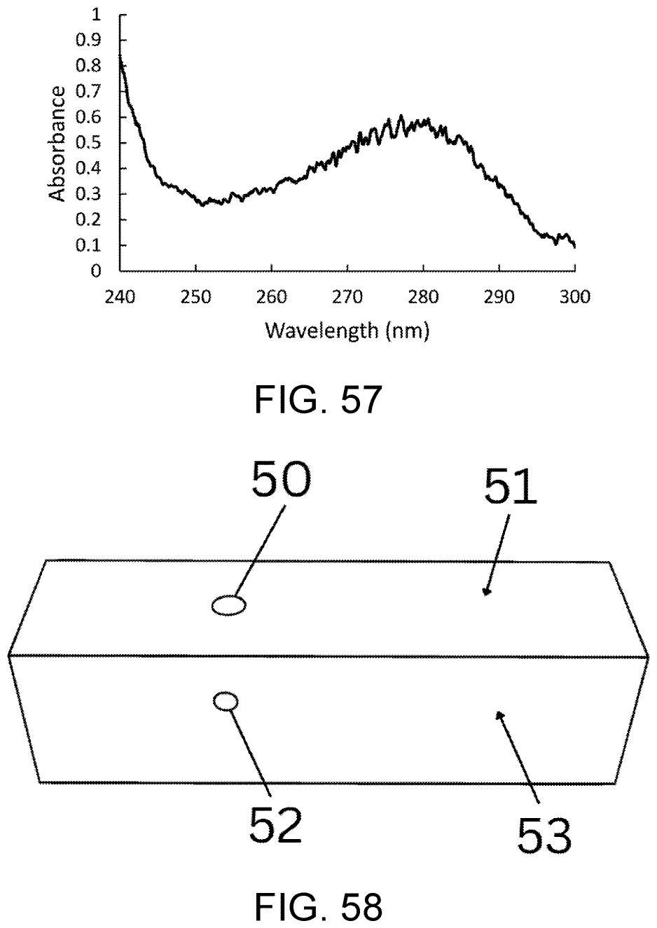

Spectrophotometric characterization was also conducted utilizing an ultra-low fluid sample volume of approximately 0.25 microliters (μL) of the BSA solution within an alternative configuration of the cuvette assembly. To accommodate the ultra-low fluid sample volume, the alternative configuration incorporated a sample chamber featuring a reduced cross-sectional radius of approximately 0.4 mm. While the nominal optical pathlength of the cuvette structure was maintained at 1.0 mm, geometric constraints of the reduced sample volume yielded a reduced effective optical pathlength. As illustrated in the representative spectrum of FIG. 57, the resulting absorbance curve resolved an absorption maximum at a wavelength of approximately 280 nm, corresponding to the characteristic protein absorbance band. The alternative configuration accommodated fluid sample volumes below the minimum operating thresholds of conventional commercial microvolume analytical devices while maintaining structural compatibility with a standard UV-Vis spectrophotometer.

In accordance with another embodiment of the present disclosure, the mechanical, optical, and structural configurations of the microvolume cuvette assembly may be adapted for alternative optical detection methodologies. For example, the cuvette assembly may be configured for alternative use in fluorescence spectroscopy applications.

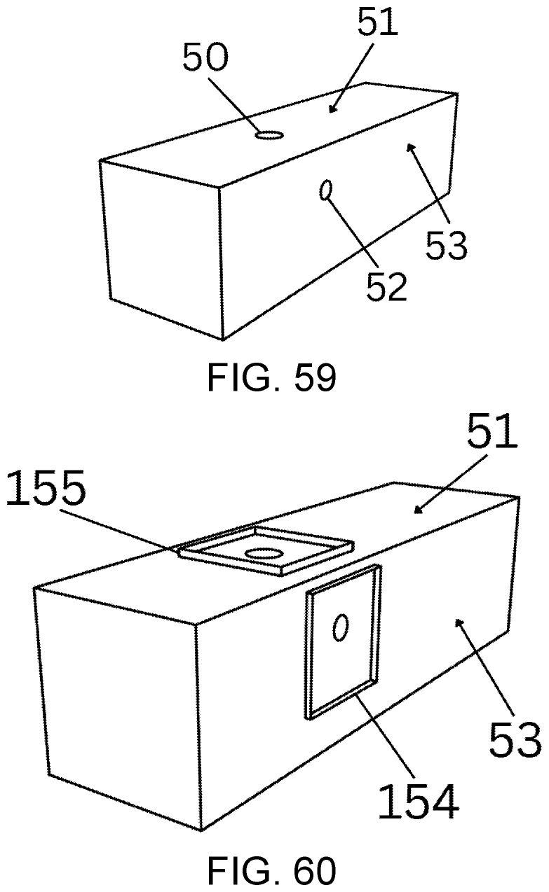

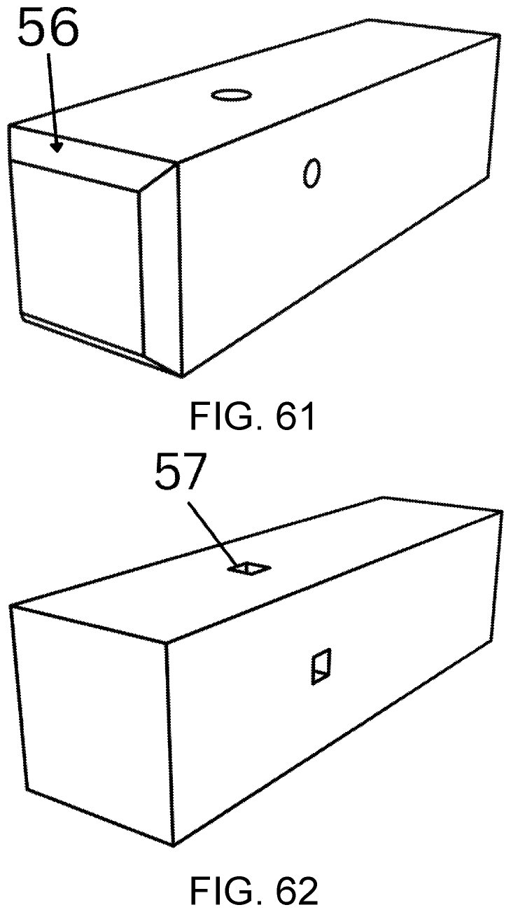

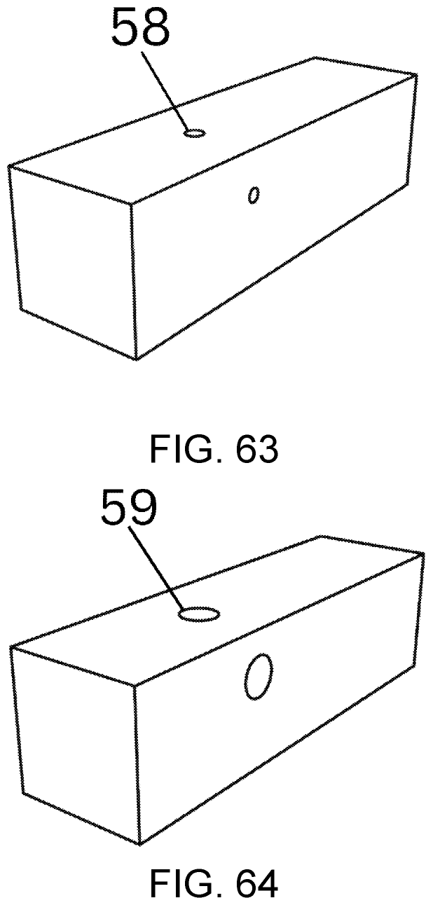

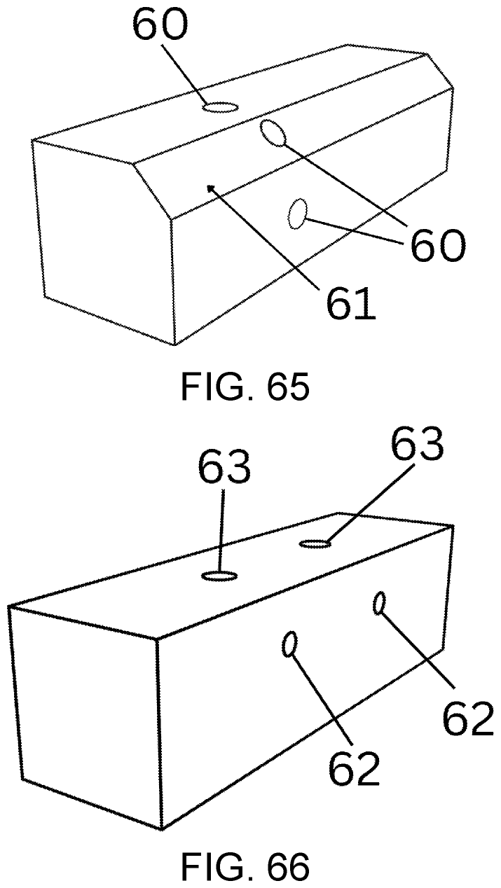

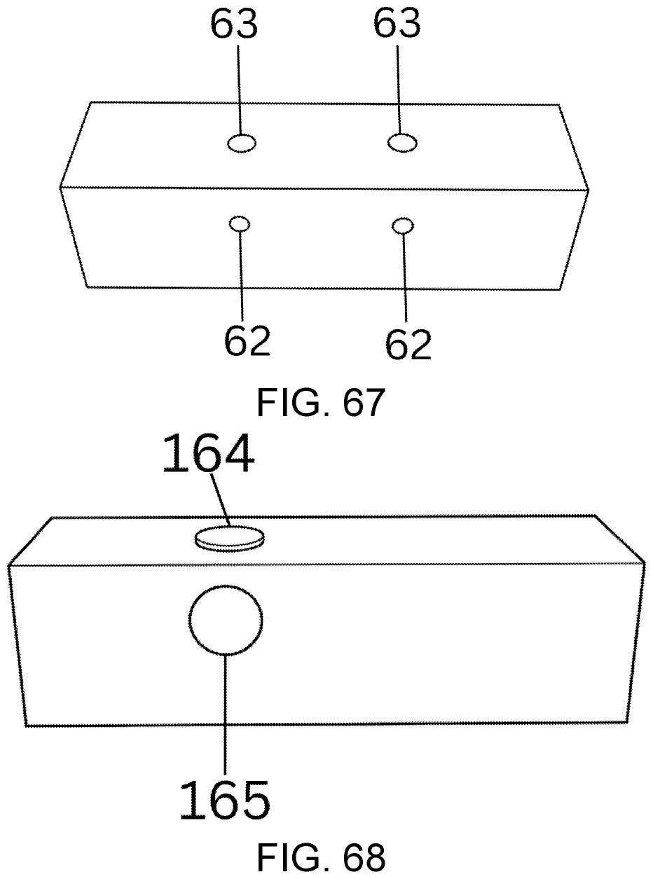

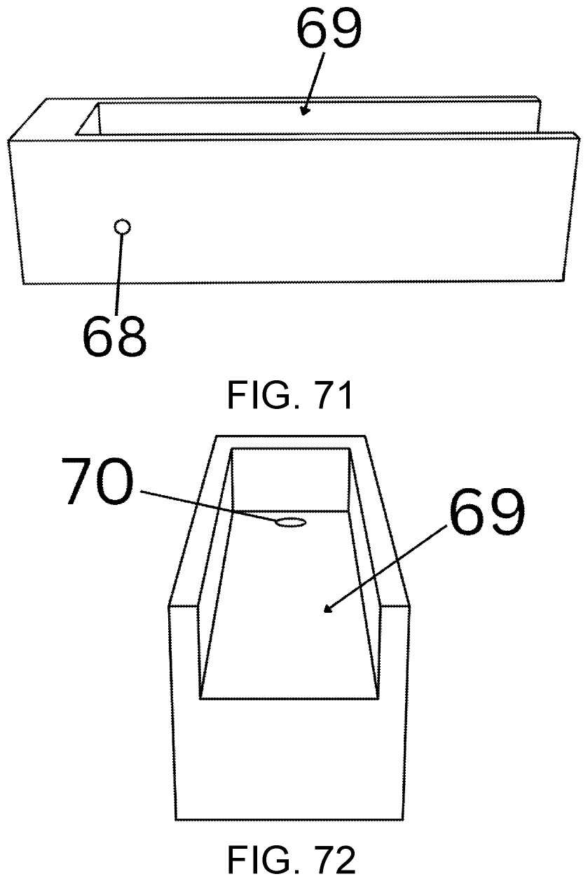

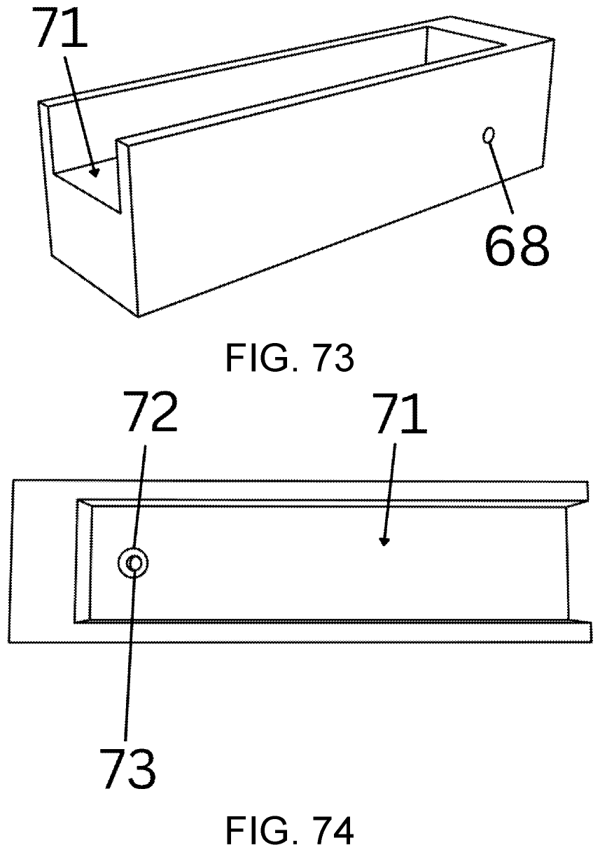

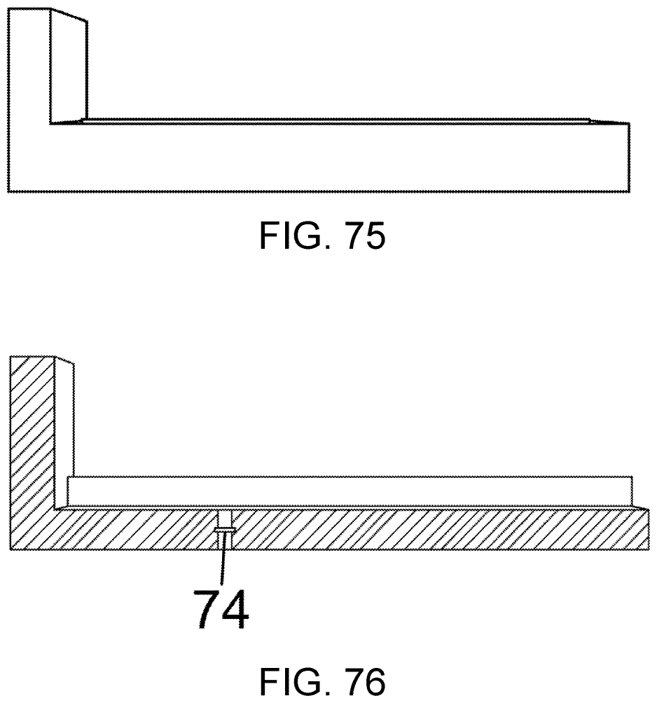

Referring to FIGS. 58-74, an alternative configuration of the cuvette assembly is illustrated to facilitate fluorescence detection. As depicted in FIG. 58, the cuvette assembly incorporates a modified optical geometry wherein an excitation channel (50) and an emission channel (52) are oriented orthogonally relative to one another. This orthogonal orientation permits the transmission of emitted fluorescent light along the emission channel (52) while blocking direct transmission of incident excitation light from entering an associated detection sensor aligned with the emission channel (52).

Structural configurations, alternative chamber geometries, and operational parameters for the fluorescence-configured cuvette assembly are set forth in further detail below.

In accordance with another embodiment, a passive fluid-retaining apparatus for fluorescence spectroscopy comprises a microvolume cuvette body (FIG. 58). The cuvette body comprises a substantially rigid, opaque material defining at least an excitation channel (50) and an emission channel (52) extending therethrough and intersecting one another orthogonally. The excitation channel (50) and the emission channel (52) are configured to align with an external excitation light source and an optical emission detector, respectively. The intersection of the excitation channel (50) and the emission channel (52) defines an internal fluid sample volume configured to receive and retain a fluid sample. The cuvette body may be configured as a single-use structure formed via injection molding or as a multi-use structure configured for manual cleaning. By localizing the fluid sample at the intersection of the excitation channel (50) and the emission channel (52), the cuvette body is configured to restrict the required interrogation volume to a microliter scale.

In one configuration, the cuvette body is formed as a substantially rectangular prism featuring external dimensions of approximately 12.5 mm×12.5 mm×45 mm. The cuvette body is penetrated by an excitation channel (50) and an emission channel (52), each originating at a respective exterior surface of the cuvette body to collectively define an internal cavity. The excitation channel (50) is positioned to align substantially parallel with an incident light beam emitted from an external excitation light source, defining an excitation pathway. The emission channel (52) is positioned to align substantially parallel with an optical collection path of an external fluorescence detector, defining an emission pathway. The excitation channel (50) and the emission channel (52) are oriented substantially orthogonal to one another and intersect at a substantially 90-degree angle within the cuvette body.

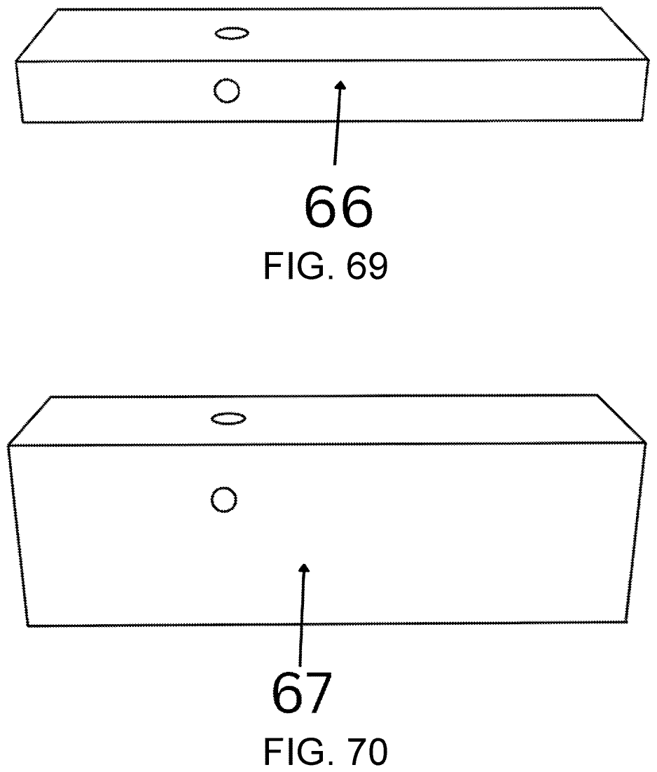

In other embodiments, the cuvette housing may include alignment aids, such as keyed corners, optical registration markings, or filleted or chamfered edges (56), configured to enhance geometric reproducibility and optical beam alignment within an instrument cuvette holder. In alternative embodiments, the cuvette body may feature modified external dimensions, such as a reduced width dimension of approximately 5 mm×12.5 mm×45 mm (FIG. 69) or an expanded width dimension of approximately 17.5 mm×12.5 mm×45 mm (FIG. 70), configured to conform to a plurality of alternative analytical instrument configurations.

Fluid volume retention within the cuvette assembly is geometrically managed by an internal sample chamber defined by the intersection of the orthogonal channels. The internal sample chamber is dimensioned to receive and retain a microliter-scale fluid sample via a combination of surface tension, capillary action, and surface adsorption, thereby maintaining the fluid sample within an optical measurement zone defined by the channel intersection. The cross-sectional profile of the orthogonal channels may vary across alternative configurations. For example, the cross-sectional profile of the orthogonal channels may be substantially circular, rectangular, square, or elliptical, or may comprise alternative geometric cross-sections configured to modulate internal fluidic flow behavior or optical transmission path parameters. An exemplary configuration featuring a substantially rectangular cross-sectional channel profile is illustrated in FIG. 62.

The depth and cross-sectional radius of the orthogonal channels are established within predefined dimensional boundaries to facilitate measurement uniformity. In some embodiments, at least one of the orthogonal channels features a cross-sectional radius ranging from approximately 0.05 mm (58) to 3.0 mm (59) to accommodate varying sample fluid volumes. The channel depth, defined by an axial distance from a peripheral outer rim of a respective channel to an internal intersection junction with an opposing channel, ranges from approximately 0.1 mm to 6.25 mm. In an embodiment, the chamber may embody a rectangular (57) or elliptical shape.

The minimum required fluid volume is determined as a function of the internal cavity geometry of the vessel body. While the physical boundaries of the internal cavity remain structurally static post-fabrication, the effective optical pathlength through the fluid sample is dynamically modifiable by the user as a direct function of the introduced sample volume. Specifically, adjusting the volumetric amount of the fluid sample alters the physical dimensions of the fluid column positioned across the optical interrogation path, wherein a greater sample volume establishes an increased effective pathlength and a lesser sample volume establishes a decreased effective pathlength within the same internal cavity. This configuration allows the effective optical pathlength to be variably calibrated at the point of use to accommodate diverse sample characteristics, such as selecting an increased effective pathlength to optimize optical transmission and signal-to-noise ratios for low-concentration analytes, without requiring structural adjustments to the physical boundaries of the vessel body.

The internal cavity of the cuvette body is configured to receive a fluid sample from an external fluid delivery device, such as a manual or automated pipette fluid tip. In some embodiments, an outer peripheral rim of at least one of the excitation and emission channels comprises a chamfered surface (72), a beveled face, or a frustoconical profile. This geometric configuration is configured to serve as a guide to facilitate axial alignment of an external fluid delivery tip relative to the channel opening and to direct the fluid sample into the internal cavity, thereby minimizing fluid diversion across peripheral surfaces during sample deposition.

Due to the microvolume scale of the fluid samples, fluid stabilization and evaporation control elements may be integrated into the cuvette body. In one embodiment, a structural sealing element, such as a removable cap, plug, or lid, is configured to selectively enclose at least one channel opening. The structural sealing element may be fabricated from a substantially chemically inert and low-vapor-permeability material, including silicone, polytetrafluoroethylene (PTFE), or polypropylene. In another configuration, the structural sealing element comprises a light-transmissive material, such as cyclic olefin copolymer (COC) or fused quartz windows (154, 155), configured to permit optical interrogation through the sealing element without structural removal thereof. The light-transmissive sealing element may be co-molded with, or separately manufactured and subsequently ultrasonically welded or solvent-bonded to, the cuvette body to promote a substantially fluid-tight interface. For removable configurations, the sealing element may engage the cuvette body via an adhesive interface, a snap-fit mechanism, a magnetic engagement mechanism, or a friction-fit interface to maintain a substantially fluid-tight seal with the cuvette body. In alternative configurations, a thin, light-transmissive polymer film may be disposed across the channel openings to inhibit fluid evaporation. The polymer film may be configured to be pierceable by an external fluid delivery device, such as a sampling needle or pipette tip, to permit fluid introduction while maintaining a sub-enclosure to mitigate vapor loss.

In an alternative embodiment, a fluid overlay configuration for mitigating sample evaporation comprises a discrete layer of a non-volatile, chemically inert, fluid-immiscible material disposed over an exposed boundary surface of the fluid sample within the sample chamber. The fluid-immiscible material, which may include mineral oil, features a density lower than that of the fluid sample and is configured to be substantially optically non-interfering within an interrogation wavelength spectrum of the spectrophotometer. The fluid-immiscible layer forms a vaporization barrier at a fluid sample-to-air interface, thereby mitigating the vapor transmission rate of the fluid sample during optical characterization intervals.

The structural and operational principles set forth in the present disclosure may be adapted across a variety of alternative geometric and functional configurations. The embodiments described herein are provided for illustrative purposes and are not intended to be exhaustive or to restrict the scope of the present disclosure to the precise forms disclosed. The legal scope of protection is defined and governed exclusively by the appended claims rather than the exemplary embodiments set forth in the descriptive specification.

In another embodiment, the opaque block further comprises an auxiliary analysis pathway that intersects the intersection of the orthogonal chambers at a non-orthogonal angle (60), in addition to the orthogonal intersection, such as an angle of approximately 45 degrees. The opaque block features an angled exterior surface (61) oriented to align substantially perpendicular to an external collection pathway. This non-orthogonal configuration is structurally arranged such that incident light scattered by a sample fluid retained at the channel intersection is directed along the auxiliary analysis pathway toward an external optical sensor to facilitate nephelometric analysis.

In an alternative configuration illustrated in FIG. 66, the cuvette body comprises a second internal cavity formed within the other half of the cuvette body to facilitate concurrent containment of multiple fluid samples. The second internal cavity features an internal geometry substantially identical to that of the first internal cavity and is symmetrically disposed within a superior portion of the cuvette body distal to the base. Structurally, the cuvette body is configured to be positioned within an analytical optical instrument to perform an optical interrogation through the first internal cavity, and is further configured to be removed from the analytical optical instrument, rotated substantially 180 degrees, and reinserted to position the second internal cavity within an optical path of the analytical optical instrument. This symmetrical configuration facilitates sequential paired-sample analysis across both internal cavities. The matching geometry of the first and second internal cavities is configured to promote uniform optical path lengths and beam alignment across both measurement zones.

Optical elements, such as lenses or optical filters (164, 165), may be integrated into the optical pathways of the cuvette assembly to modulate light transmission or pass/block specific light wavelengths, respectively. In one embodiment, a first optical element comprising a converging lens is disposed within an incident optical path to focus incident light from an external excitation source into the excitation channel, thereby increasing excitation photon density within the fluid sample. In another embodiment, a second optical element comprising a collection lens is disposed adjacent to an exterior exit face aligned with the emission pathway to collect and direct fluorescent emission from the internal cavity onto an external photodetector. In an alternative configuration, at least one exterior surface of a light-transmissive portion of the cuvette body comprises a convex curvature configured to define an integrated lens structure for focusing or collecting light. In configurations featuring a plurality of internal cavities, a microlens array may be disposed on an exterior surface of the cuvette body, wherein each individual microlens element of the microlens array is structurally aligned with a respective sample chamber to facilitate multi-channel optical interrogation. In another embodiment, optical filters with the wavelengths of interest may be integrated into the optical pathways of the cuvette to modulate the excitation/emission wavelength for specific fluorescence signal collection.

The cuvette body may incorporate alternative structural modifications. In one embodiment, the cuvette body comprises one or more physical registration features configured to promote reproducible geometric alignment within an instrument receptacle. The registration features may include a body alignment chamfer (56), a kinematic mounting interface, or structural fiducial markings configured to be detected by an optical alignment sensor within an external instrument. In alternative embodiments, the external dimensions of the cuvette body may be configured to conform to alternative industry form factors or instrument-specific receptacle geometries. For example, the cuvette body may feature a restricted width dimension of approximately 5 mm (66) configured for compatibility with narrow receptacle slots, or an expanded width dimension of approximately 17.5 mm (67) configured to accommodate expanded optical path cross-sections or integrated auxiliary components. Furthermore, the overall architectural form factor of the cuvette body may be adapted to non-standard multi-axis dimensions, including a reduced vertical height configuration to accommodate low-clearance optical arrays or an increased axial length configuration to accommodate fluidic ports or integrated sensors.

In an alternative configuration, a portion of an excitation entry face of the cuvette body is recessed or reduced in thickness to restrict an optical pathlength of the cuvette assembly, as illustrated in FIG. 72. By reducing the axial distance of the optical pathlength through which incident excitation light and emitted fluorescent light travel within a fluid sample, the recessed excitation entry face (69) is configured to mitigate emission signal attenuation caused by sample reabsorption. The restricted optical pathlength is further configured to modulate emission signal intensity to inhibit optical sensor saturation across elevated sample analyte concentration thresholds. Similarly, a portion of the emission exit face of the cuvette body may be recessed or reduced in thickness to alter an emission pathlength, thereby promoting signal linearity within the optical measurement zone.

In another embodiment illustrated in FIG. 76, an internal channel of the cuvette body further comprises a geometric bubble trap (74) disposed adjacent to or contiguous with the internal cavity. The geometric bubble trap (74) is configured to passively isolate entrained gaseous bubbles from the optical path length during capillary fluid introduction into the internal cavity. In one configuration, the geometric bubble trap comprises a localized channel widening defining an abruptly expanded cross-sectional area of the internal cavity. The localized channel widening is configured to generate a capillary pressure differential across an advancing fluid front, causing entrained gaseous bubbles to preferentially migrate into and remain pinned within the geometric bubble trap.

Conventional analytical platforms designed for microvolume spectrophotometry frequently present operational compromises between fluid sample volume requirements, optical path precision, and system architecture complexity. Certain microfluidic or thin-film configurations minimize sample volumes but often require specialized external optical alignment arrays or proprietary docking hardware that may be incompatible with standard, commercially available spectrophotometer receptacles. Additionally, alternative fluid containment structures may exhibit mechanical instability, susceptibility to geometric variance under thermal loading, or axial misalignments that introduce optical artifacts into the measurement path. Consequently, challenges remain in providing a fluid containment assembly that maintains structural and optical path integrity while remaining physically compatible with standard analytical instrument interfaces.

Certain standalone analytical platforms utilize microvolume droplet-retention mechanisms to compress or draw a fluid sample into an exposed liquid column. As described, for example, in U.S. Pat. Nos. 6,628,382; 6,809,826; and 9,442,009, these systems employ surface-tension-based fluid retention architectures featuring parallel optical surfaces on translating pedestals or pivotally closing arms to dynamically modulate an internal measurement pathlength. While such platforms reduce required sample volume parameters relative to 10 mm cuvettes, they rely on specialized standalone instrument hardware containing exposed fluid-to-air sample interfaces and dynamic mechanical translation elements. Consequently, the liquid sample column remains highly subject to ambient evaporation during interrogation, and the exposed optical surfaces are susceptible to calibration variance or environmental contamination. Furthermore, such standalone hardware architectures lack structural compatibility with standard, pre-existing cuvette-based spectrophotometer sample receptacles.

Alternative analytical instrument configurations utilize variations of the dual-pedestal, open-column architecture. Such configurations may incorporate alternative optical routing paths, localized hydrophobic surface coatings, or integrated dampening mechanisms to stabilize structural movement. However, these architectural variations maintain a standalone instrument footprint requiring dedicated electrical, processing, and optical subsystems. Consequently, these configurations are not configured to operate as modular or interchangeable accessories within pre-existing spectrophotometer systems that utilize standard cuvette receptacles, thereby limiting the utility of existing laboratory instrumentation for microvolume analytical procedures.

Other conventional configurations utilize planar substrates featuring at least one perforation, as described, for example, in U.S. Pat. No. 7,576,855. This architecture relies on tapered through-holes to suspend fluid sample volumes ranging from approximately 1.0 microliter to 2.0 microliters via surface tension along a vertical optical interrogation path. Because this structural orientation establishes a vertical optical axis, it is not directly compatible with the horizontal optical pathways standard in many existing laboratory spectrophotometer receptacles. Adapting such horizontal systems to interface with a vertical optical plate configuration requires auxiliary light-redirection optics or specialized multi-axis alignment stages. Additionally, because the fluid sample is retained as an exposed droplet within a through-hole, the fluid interface remains open to the ambient atmosphere, which can increase the rate of vaporization or permit unconstrained fluid spreading across the planar substrate, potentially introducing optical variance into the measurement path.

Other conventional configurations utilize fiber-optic coupled flow cells configured for continuous or process-stream optical monitoring, as described, for example, in WIPO Patent Application Publication No. WO 2022/026455. These architectures direct a fluid sample stream through an enclosed internal measurement chamber via inlet and outlet fluidic connectors, with fiber-optic light-transmissive elements provided by a separable sensor unit that attaches to the flow cell. Because these systems rely on active external fluid routing for the primary process stream, they require auxiliary hardware such as mechanical pumps and fluidic tubing networks, which introduce unrecoverable internal dead volume and increase the physical footprint of the active testing loop. The integrated fluidic conduits and flow cells can additionally be susceptible to clogging from particulate matter or optical surface abrasion. However, to facilitate calibration, such configurations integrate a standard cuvette-receiving architecture directly into the sensor assembly, allowing the introduction of static material standards or discrete calibration samples alongside the primary fluidic loop. Unlike the present disclosure, in which the cuvette body itself serves as the primary microvolume measurement vessel, the cuvette-receiving architecture of such flow-cell configurations is utilized exclusively for the introduction of static calibration standards and is not configured to perform primary microvolume analyte measurements within a standard spectrophotometer receptacle.

Alternative microvolume analytical configurations utilize microfluidic or lab-on-a-chip substrates featuring embedded microchannels, as described, for example, in U.S. Pat. Nos. 7,483,138; 7,688,429; 9,025,152; and 11,644,408. These platforms typically direct fluid samples through restricted internal pathways to conduct optical interrogation via integrated optical waveguides or interface fiber nodes. Such configurations generally utilize auxiliary external equipment, including mechanical fluid pumps, pressure controllers, or specialized chip-holding alignment jigs to interface with an external light source. While certain embodiments of the present disclosure may similarly utilize short optical pathlengths at or below 200 micrometers to accommodate ultra-low sample volumes, the cuvette assembly of the present disclosure achieves this within a passive, open-access sample chamber that requires no external pumping hardware, fluidic tubing, or dedicated chip-holding alignment hardware, and is structurally configured for direct insertion into a standard spectrophotometer cuvette receptacle without instrument modification. Furthermore, these enclosed microfluidic architectures can be susceptible to particulate accumulation or precipitate formation within the internal conduits and may be subject to optical path disruption from entrained gaseous bubbles within the microchannels. These configurations are typically designed for dedicated microfluidic analysis instrumentation and lack the structural form factor required for direct drop-in replacement within a standard spectrophotometer cuvette receptacle.

Alternative analytical configurations utilize planar waveguides or thin-film optical sensors, as described, for example, in U.S. Pat. Nos. 5,082,629 and 6,335,793. These platforms typically rely on light-transmissive substrates or surface coatings to detect refractive index modifications or evanescent field interactions upon fluid sample contact. Because these configurations primarily measure molecular interactions adjacent to a sensor interface boundary layer rather than transmitting an optical beam through a bulk volumetric path, they may not be configured for standard transmission-based analyte quantification of homogeneous solutions. Furthermore, this localized interaction zone can be susceptible to optical path interference from surface contamination, non-specific molecular binding, or localized gaseous bubbles, which can necessitate specialized surface passivation steps or complex substrate fabrication. Additionally, these waveguide architectures typically require specialized coupling optics, custom illumination sources, and non-standard detector configurations and lack the structural form factor required for direct drop-in insertion into a standard, horizontal-beam spectrophotometer cuvette receptacle.

Alternative analytical configurations utilize surface plasmon resonance (SPR) or localized surface plasmon resonance (LSPR) architectures, as described, for example, in U.S. Pat. Nos. 5,485,277; 7,483,140; and 9,658,157. These platforms typically monitor localized refractive index modifications or enhanced electromagnetic extinction signatures at a metal-dielectric interface layer. Because the optical interaction in these configurations is primarily confined to an evanescent electromagnetic field extending a restricted distance from the interface boundary layer, the optical interrogation path does not extend through the bulk volume of a fluid sample. Consequently, these systems may not be configured for standard transmission-based volumetric quantification of homogeneous solutions. Additionally, such configurations typically utilize specialized prism coupling elements, grating couplers, or microfluidic sensor arrays and lack a structural form factor configured for direct drop-in insertion into a standard, horizontal-beam spectrophotometer cuvette receptacle.

U.S. Pat. No. 4,088,448 discloses an analytical configuration restricted to a closed, pre-packaged reagent system. The transparent cuvette in the prior disclosure requires a surface-deposited chemical payload within its cavities to function, legally and structurally limiting its utility to specific, pre-determined chemical assays. Because the prior art cuvettes'apparatus is inextricably tied to this integrated chemical payload, it lacks the fluidic neutrality and open architecture required to safely and effectively accommodate arbitrary, un-reagentized fluid samples without risk of chemical cross-contamination or structural incompatibility. Additionally, in contrast to the multi-window containment architecture of the prior art, the presently disclosed apparatus is configured to suspend the liquid sample droplet openly in the chamber without bounding physical walls obstructing the beam path, thereby completely eliminating optical pathlength variances, surface reflections, and material attenuation inherent to physical containment windows.

Other conventional configurations utilize analytical apparatus designed to measure fluorescence, luminescence, phosphorescence, Raman scattering, and absorption in small liquid sample volumes, as described, for example, in U.S. Pat. No. 9,297,760. The apparatus disclosed therein comprises a sample holder fabricated from synthetic quartz glass, having an open upward-facing receiving point into which a liquid sample of approximately 10 μL or less is applied or dripped, and is housed within an external profile dimensionally compatible with standard spectrophotometer cuvette receptacles (12.5 mm×12.5 mm). Internal optical components, including light-deflecting prisms and light guides, redirect excitation and emission beams to and from the sample receiving point. While the disclosed apparatus achieves reduced sample volumes relative to conventional cuvette cells, it is configured as a reusable instrument accessory that, between sequential measurements, requires physical wiping or liquid cleaning of the sample-receiving point to mitigate cross-contamination and analyte carryover. Furthermore, the apparatus relies on a rigid assembly of precision optical components—including total internal reflection prisms, light-conducting elements, and a structured sample holder—that must maintain precise geometric alignment to preserve optical performance and is not suited to single-use disposable implementation. Unlike the apparatus disclosed therein, the cuvette assembly of the present disclosure does not rely on internal light-redirecting optical components such as prisms or light-conducting elements to route excitation or emission beams, but instead maintains a direct, unobstructed optical path through the fluid sample. Additionally, the passive open-access chamber geometry of the present disclosure, which retains fluid samples via surface tension and capillary action without enclosed internal conduits, permits straightforward cleaning for reusable configurations and eliminates per-measurement cleaning requirements entirely in single-use configurations, thereby reducing operational complexity and cross-contamination risk relative to the wiping-dependent cleaning protocol of the prior art apparatus.

Another conventional disposable analytical vessel utilizes passive capillary fluid transport, as described, for example, in U.S. Pat. No. 5,674,457. This configuration comprises an integral molded body member defining a fixed-pathlength measuring cavity coupled to a peripheral capillary channel of elevated capillary force, through which a fluid sample is drawn inward from an outer edge inlet to populate the measuring zone. Because the internal cavity is defined by two enclosed, substantially parallel planar surfaces, the internal optical surfaces are not directly accessible for cleaning or fluid extraction, rendering the vessel suitable for single-use disposable operation rather than multi-use sequential sampling. Furthermore, the disclosed architecture does not describe compatibility with the standardized external dimensional envelope of a horizontal-beam spectrophotometer cuvette receptacle, and the enclosed capillary geometry does not provide the open-surface sample loading access characteristic of the present disclosure.

Other integrated analytical platforms utilize a capillary-based fluid pathway lined with specific chemical reagents, as described, for example, in U.S. Pat. No. 6,333,007. These configurations often employ laminated layers defining an internal capillary chamber containing a dried chemical payload configured to solubilize and mix with an introduced biological fluid sample to execute targeted colorimetric analysis. Because these platforms rely on full volumetric priming of a sealed internal capillary network to establish a stable fluid front, they typically require sample volumes scaled to the absolute geometry of the internal fluidic pathway. Additionally, the inclusion of internal reagent matrices and narrow, non-accessible fluidic pathways adapts the assembly primarily for single-use diagnostic applications, as residual fluids or chemical reaction products remaining within the capillary sections are structurally shielded from manual extraction or flushing. Furthermore, such specialized diagnostic configurations are typically adapted for dedicated, standalone photometric readers and lack the standard external form factor required for direct drop-in integration into a conventional, horizontal-beam laboratory spectrophotometer receptacle.

Another conventional analytical vessel configuration features a reduced-pathlength measurement zone optimized for discrete wavelength detection, as described, for example, in U.S. Pat. No. 9,651,564. These vessels are configured as disposable microcuvettes with a measuring zone having an optical path of approximately 0.10-0.25 mm, intended for use with a light source emitting only two specific wavelengths—one between 520 and 590 nm and a second of at least 800 nm—rather than a continuous or broadband spectrum. The disclosed light source may be an LED, a laser diode, or a continuous light source with a filter, and is paired with a dedicated diffuser, light and detector guides of fixed inner diameters, and a cuvette holder and accommodating member configured to align the measuring zone with these components within a specialized instrument housing. Because the geometry of the cuvette holder and the optical guides are dimensioned to match this specific instrument interface, and because the cuvette itself is structured around a capillary inlet and sample slot rather than a standard cuvette form factor, these vessels do not appear structurally configured for modular drop-in insertion into a conventional, horizontal-beam laboratory spectrophotometer cuvette receptacle.

Alternative analytical configurations utilize multi-component mechanical hardware featuring pivotally connected structural arm components to manage sample positioning, as described, for example, in the hinged quartz micro-cuvette architectures described in the U.S. Pat. No. 9,677,994. Because these architectures rely on a moving mechanical joint to repeatedly guide or execute sample delivery configurations across successive cycles, maintaining structural tolerances relies heavily on the mechanical precision of the hinge mechanism, which may be subject to wear or alignment drift over extended operational life. Separate configurations utilizing pivotally connected arms for sample containment—such as closed-cell quartz micro-cuvette systems—typically present reusable geometries demanding intensive, manual cleaning protocols between sequential operations to prevent cross-contamination. Furthermore, the fluidic interfaces of these articulated closed-cell geometries are restricted by rigid structural boundaries that complicate manual pipetting and lack a static internal cavity configuration optimized to passively isolate and contain ultra-low fluid volumes within a standard spectrophotometer cuvette receptacle.

Alternative analytical vessel configurations incorporate internal microstructures, such as an array of upwardly extending structural pillars and localized surface coatings, to direct a fluid sample via capillary action across an internal optical pathway, as described, for example, in European U.S. Pat. No. 3,230,714. While these internal structural matrices serve to constrain fluid movement, the structural spacing and displacement parameters of the pillar arrays generally utilize minimum fluid sample volume thresholds of several microliters to fully occupy the optical path. Additionally, the presence of an integrated microstructure matrix within the internal fluid cavity establishes restrictive interior geometries that can resist complete fluid evacuation or retain residual analyte materials. This internal configuration can complicate direct physical access to the fluid-contacting surfaces, thereby making surface decontamination or rinsing protocols difficult between successive sampling operations. Furthermore, such micro-structured internal cavity configurations lack an obstruction-free internal chamber geometry optimized to passively isolate and contain sub-microliter fluid volumes within a standard, horizontal-beam spectrophotometer cuvette receptacle.

Another conventional analytical vessel configuration utilizes a modified internal cavity geometry to alter fluid surface profile characteristics, as described, for example, in European U.S. Pat. No. 2,466,291. This architecture incorporates localized internal boundary geometries to minimize optical distortion induced by the liquid meniscus across fluid sample volumes ranging from approximately 20 microliters to 50 microliters. However, these specialized internal configurations typically require minimum fluid sample thresholds of approximately 20 microliters or greater to span the internal optical pathway and achieve the stabilized fluid interface profile. Additionally, due to the configuration of the custom internal chamber boundaries, the external profile or alignment surfaces of the vessel may require auxiliary adapter elements to achieve proper optical alignment within standard, horizontal-beam laboratory spectrophotometer cuvette receptacles. Furthermore, the geometric tolerances required to maintain the anti-curvature internal boundaries adapt the vessel primarily for specialized testing environments, and the assembly lacks an unobstructed internal chamber geometry optimized to passively isolate and contain sub-microliter fluid volumes within a conventional drop-in spectrophotometer cuvette interface.

Alternative microvolume analytical configurations utilize a fiber-optic pedestal interface requiring a separate cap assembly, such as those disclosed in U.S. Pat. No. 8,537,352B2. These systems incorporate an internal fiber-optic path to direct an optical beam through a fluid sample droplet deposited onto a planar optical surface, wherein a separate cap enclosing a reflective element must be manually positioned over the droplet to return the optical beam along a dual-pass vertical measurement path. While this multi-component arrangement allows for the analysis of fluid sample volumes down to approximately 0.7 microliters within an external form factor sized for standard cuvette receptacles, the mechanical interaction between the separate cap assembly and the sample platform introduces potential operational variations. Specifically, repeated manual placement and alignment of the separate cap relative to the optical pedestal can induce structural alignment drift or wear on the positioning interfaces over extended operational cycles. Furthermore, because the configuration incorporates integrated fiber-optic nodes and precise reflective components within distinct sub-assemblies, the structural interfaces can be sensitive to liquid immersion or automated ultrasonic cleaning protocols, thereby adapting the device primarily for manual surface wiping between sequential sampling steps. Additionally, these multi-component capped architectures lack an open-access internal cavity geometry optimized to passively isolate and contain ultra-low fluid volumes without auxiliary moving or mating components.

In yet other arrangements, enclosed flow cell cuvette assemblies incorporating light-masking window segments, as utilized in conventional dynamic fluid-monitoring systems. These architectures typically incorporate integrated inlet and outlet port structures to continuously or sequentially direct a fluid sample stream through an internal measurement chamber. Because these systems are configured for continuous or dynamic fluid routing, they rely on auxiliary external hardware, including fluidic couplings, external tubing networks, and mechanical fluid-delivery pumps. Volumetrically, the fluidic overhead required to fully prime and occupy the internal measurement chamber and its associated fluidic interfaces establishes a minimum volume threshold dictated by the total internal capacity of the fluid routing loop. Consequently, these dynamic flow cell configurations are primarily adapted for active process-monitoring environments and lack a standalone internal cavity geometry optimized to passively isolate and contain a static, sub-microliter fluid volume within a standard, horizontal-beam laboratory spectrophotometer cuvette receptacle.

Alternative analytical vessel configurations incorporate a structural inlet interface to direct a fluid sample into a restricted measurement pathlength cavity, as utilized in conventional short-path microvolume systems. These assemblies typically feature an inlet platform configured to receive fluid from a dispensing tip and guide it into a fixed-path-length internal measuring cavity aligned with an aperture formed through the vessel body. Because of the fluidic resistance and internal surface geometry of the housing, these configurations generally utilize fluid sample volume thresholds ranging from approximately 12 microliters to 50 microliters to fully prime the internal measurement zone. Additionally, these systems rely on a multi-component arrangement utilizing separate, single-use fluidic introduction plates that must be mechanically manipulated between distinct testing cycles, adapting the vessel primarily for independent disposable operations rather than multi-use cycles requiring rapid consecutive sample changes on the structure. Furthermore, because the internal measuring cavity is bounded by rigid, predetermined structural walls, the spatial configuration establishes an unalterable physical optical pathlength. Consequently, these configurations lack an open-access internal chamber geometry configured to passively isolate and contain sub-microliter fluid volumes while permitting direct physical access to the internal optical surfaces within a standard spectrophotometer cuvette receptacle.

Alternative analytical measurement approaches employ a traceable method for determining the optical path length of a drop-based sample in a micro-volume spectrophotometer, as described in U.S. Pat. No. 8,947,668. In this approach, a drop analyzer is coupled to a standard spectrophotometer, and absorbance calibration is established using certified reference materials contained in closed high-accuracy cuvettes having path lengths in the range of 1 to 10 mm and dimensional tolerances of up to 0.001 mm. A dropper deposits a specified volume of solvent—typically on the order of 3 microliters—onto an optical surface, and the resulting path length of the drop is determined by reference to absorbance measurements obtained from the calibrated cuvettes. The same volume of the unknown sample is then deposited and measured under substantially the same conditions, enabling traceable absorbance results. Measurements are preferably performed at multiple wavelengths, such as 258 nm, 416 nm, and 630 nm, and ideally conducted simultaneously through the same optical path to minimize instrumental drift. Because path length is determined indirectly through comparison against certified reference absorbance values rather than being defined by a fixed rigid chamber, this method accommodates variable drop geometries while maintaining metrological traceability to international standards. However, this methodology serves poorly as a low-cost replacement to the cuvette of the present disclosure because it requires expensive external analyzer attachments and meticulous reference standards rather than a standalone cuvette cell. Furthermore, its multi-step calibration workflow and high 3-microliter volume floor cannot support rapid, sub-microliter (0.25 μL) handling within a standard, unmodified spectrophotometer receptacle.

Alternative analytical configurations utilize specialized tube-based assay vessels adapted for target-specific fluorogenic quantification within dedicated fluorometric readers. These systems typically require a fluid sample to be processed alongside exogenous fluorogenic dyes within custom-molded micro-tubes configured to interface with a corresponding specialized instrument nest. Because the external geometry and optical orientation of these assay vessels are constrained to match a dedicated standalone instrument housing, they lack an external form factor configured for direct, drop-in insertion into a standard, horizontal-beam laboratory fluorometer cuvette holder receptacle. Geometrically, the internal fluid containment cavity of these tube structures establishes a fixed, unalterable physical optical path length through the fluid sample. Consequently, these configurations lack a standalone, open-access internal chamber geometry configured to passively isolate and contain a static, sub-microliter fluid volume across diverse assay frameworks without requiring dedicated vessel-mating interfaces.

Alternative multiplexed analytical configurations utilize a multi-sample fluorometric apparatus adapted to receive a plurality of standardized thin-walled micro-tubes, such as 0.2 milliliter polymerase chain reaction (PCR) vessels. These systems typically incorporate an internal optical routing or detector array configured to sequentially scan the array of vessels arranged within an integrated sample nest. Because these platforms operate as independent, standalone instruments requiring integrated measurement circuitry and specialized electronic user interfaces, they lack an external form factor configured for modular drop-in insertion into a standard, horizontal-beam laboratory fluorometer cuvette holder receptacle. Volumetrically, the containment geometry of such micro-tubes requires a fluid sample volume threshold of approximately 10-50 microliters to establish a sufficient liquid column height across the internal optical path of the scanning array. To satisfy this internal volume constraint, low-volume fluid analytes ranging from approximately 0.1 to 10 microliters must undergo exogenous dilution protocols with specialized fluorescent dye solutions, introducing auxiliary fluid-manipulation steps and incubation intervals prior to measurement. Consequently, these configurations lack a standalone, internal cavity geometry optimized to passively isolate and contain a static, sub-microliter fluid volume across diverse assay frameworks without requiring vessel-mating nests or external fluid dilution.

Alternative analytical configurations utilize specialized single-tube fluorometric quantification platforms featuring discrete optical excitation and emission channels, which deploy target-specific fluorogenic dye-binding chemistries such as those disclosed in U.S. Pat. Nos. 8,598,198 and 9,206,474. These assay systems execute biomolecular quantification within a dedicated instrument housing enclosing active detection circuitry and integrated digital display interfaces. Because the external geometry and optical orientation of these standalone assay instruments are adapted to match a specific internal tube nest, they lack an independent external form factor required for modular drop-in insertion into a standard, horizontal-beam laboratory spectrophotometer or fluorometer cuvette holder receptacle. Furthermore, these platforms typically operate via active electronic sensing and processing components that rely on regulated environmental operating conditions to maintain baseline signal stability, such as specific thermal boundaries maintained between approximately 4 and 40 degrees Celsius under non-condensing atmospheric conditions. Geometrically, the internal fluid containment cavity of these tube structures establishes a fixed, unalterable physical optical path length through the fluid sample, preventing user modification or optimization of pathlength parameters to accommodate highly concentrated analytes. Consequently, these configurations lack a standalone internal cavity geometry optimized to passively isolate and contain a static, sub-microliter fluid volume across diverse assay frameworks without requiring dedicated vessel-mating nests or active electronic infrastructure.

Alternative multi-well analytical profiling plates are configured for use with microplate reader instrumentation employing a vertical optical path, such as the wavelength-selection platform described in U.S. Pat. No. 9,733,124, in which light is directed to a top or bottom side of a microplate inserted into the reader housing, rather than along a horizontal path through a cuvette shaft. Because conventional microplates used with such readers are dimensioned and configured for insertion into a reader's internal microplate-receiving stage—with sample wells addressed individually from above or below by the instrument's optical system—these plates lack the external dimensions, footprint, and alignment features needed for direct, modular drop-in insertion into a standard, horizontal-beam laboratory spectrophotometer or standalone fluorometer cuvette holder receptacle. The optical path through each well in such systems is likewise defined by the geometry of the well and the instrument's vertical illumination and detection optics, rather than by a path length that can be set or adjusted by a user positioning a discrete cuvette in a horizontal beam. Consequently, this class of multi-well configurations does not provide a standalone, open-access internal cavity geometry suited to passively isolating and containing a static, low-volume fluid sample within a standard horizontal cuvette interface.

In accordance with other analytical approaches, instrumentation arrays utilize multi-detector spectroscopic configurations pairing an excitation monochromator with simultaneous absorption and multi-channel fluorescence detection systems, as described, for example, in U.S. Pat. No. 10,168,310. The prior art platform contemplates placing a sample within a conventional cuvette, and employs a beamsplitter to direct a portion of the excitation beam to a reference detector, which is used to adjust the absorbance measurement; a computer or processor then corrects the fluorescence measurement using this adjusted absorbance value, obtained simultaneously with the fluorescence measurement. The fluorescence detector in this architecture is positioned to detect light emitted by the sample perpendicular to the excitation beam, consistent with a conventional right-angle detection geometry. The prior art does not describe a passive fluid-containment vessel, nor does it address sample volume, integration into existing spectrophotometer hardware, or a cavity geometry for isolating and routing light through small or static fluid volumes independent of the instrument's active optical and electronic components.

Additionally, conventional analytical vessel configurations utilize high-precision quartz cuvette structures featuring enclosed micro-cavities constructed within a standard external footprint, as utilized in conventional low-volume fluorometric analysis. These vessels typically incorporate an internal fluid chamber bounded by three or more optically polished windows arranged to facilitate ninety-degree orthogonal excitation and emission light paths across a fixed internal pathlength. Because the fluid containment zone is restricted within an enclosed, rigid internal cavity, these configurations generally require minimum fluid sample volume thresholds of approximately 45 microliters or greater to completely fill the measurement zone and minimize optical scattering along the upper cavity boundaries. Additionally, due to the fully enclosed internal geometry of the fluid channel, these assemblies rely on sequential fluid evacuation and fluidic rinsing protocols between distinct sampling steps to mitigate analyte carryover. Furthermore, because the interrogation beam must traverse the physical material thickness of the rigid chamber walls, the configuration introduces baseline optical transmission parameters dictated by the material interfaces. Consequently, these configurations lack a standalone, open-access internal chamber geometry optimized to passively isolate and contain a static, sub-microliter fluid volume within a standard fluorometer cuvette holder interface.

Alternative disposable microfluidic architectures utilize multi-component vessel assemblies configured for short-path fluorometric measurements. These configurations typically combine a specialized fluidic inlet platform featuring integrated fluid couplings, such as hose-barb connector interfaces, with a microfluidic housing enclosing internal fluid channels and orthogonal emission window segments. Because these systems rely on aligning and bonding discrete substrate layers and fluidic connection components together, the multi-component layout introduces interior material transitions along the internal sample pathway. Operationally, these internal fluid routing paths and fluidic couplings can introduce localized fluid retention or fluidic dead volume zones within the sample delivery sequence. Volumetrically, the fluidic overhead required to fully prime and fill the internal microchannels establishes minimum operational fluid sample thresholds ranging from approximately 25 microliters to 100 microliters. Furthermore, because the internal measuring cavity is bounded by fixed, rigid internal walls, the spatial configuration establishes a predetermined, unalterable physical optical pathlength, such as a fixed 1 millimeter or 2 millimeter optical boundary. Consequently, these multi-component configurations lack a standalone, open-access internal chamber geometry optimized to passively isolate and contain sub-microliter fluid volumes while permitting direct physical access to the internal optical surfaces within a standard spectrophotometer or fluorometer cuvette holder receptacle.

Alternative analytical configurations utilize integrated microfluidic or lab-on-a-chip platforms incorporating etched or molded micro-channels fluidically coupled to localized optical detection regions, as described, for example, in U.S. Pat. Nos. 11,808,704 and 7,427,509. Structurally, these platforms rely on precision microfabrication processes to define the micro-scale cross-sectional geometries of the internal channel networks, thereby configuring the substrate as an integrated microfluidic manifold. Operationally, these microfluidic channels typically rely on auxiliary peripheral instrumentation, such as external fluid-delivery pumps, pneumatic valves, or automated fluidic control networks, to drive and regulate fluid transport through the internal microfluidic pathways. Furthermore, because the internal fluid boundaries are defined by rigid, integrated channel walls, the structural architecture establishes a fixed and unalterable physical optical path length through the fluid sample. Consequently, these microfluidic configurations are primarily adapted for automated or instrument-driven analytical environments and lack a standalone, open-access internal cavity geometry optimized to passively isolate and contain a static, sub-microliter fluid volume within a standard horizontal-beam spectrophotometer or fluorometer cuvette-holder receptacle.

Alternative analytical vessel configurations utilize sub-standard footprint microcuvettes fabricated from optical quartz substrates, as utilized in conventional small-volume fluorometric sampling. These vessels incorporate reduced external cross-sectional profiles, such as dimensions measuring approximately 3 millimeters by 3 millimeters by 40 millimeters, or approximately 5.5 millimeters by 5.5 millimeters by 40 millimeters, and may include a removable fluoropolymer upper cover structure to enclose the internal cavity. Because of these reduced external dimensions, the vessels lack the standard physical footprint required to directly self-support or properly align within a standard-sized laboratory spectrophotometer or fluorometer cuvette receptacle, typically requiring auxiliary structural adapter components or external mechanical holders to establish accurate optical alignment with the excitation light path. Geometrically, the internal fluid containment cavity establishes a fixed, unalterable physical optical path length, such as a permanent 3 millimeter or 5.5 millimeter optical boundary. Volumetrically, the structural dimensions of these enclosed configurations utilize minimum fluid sample volume thresholds ranging from approximately 160 microliters to 280 microliters to fully occupy the internal optical path and avoid scattering along the upper fluid-air interface. Consequently, these configurations lack a standalone, open-access internal chamber geometry optimized to passively isolate and contain a static, sub-microliter fluid volume within a standard-footprint cuvette holder interface without auxiliary mounting hardware.

Alternative disposable optical configurations utilize molded plastic semi-micro analytical vessels fabricated from polymethyl methacrylate (PMMA) materials to facilitate single-use fluorometric measurements. These vessels typically feature an open-top structure defining a fixed internal optical path, such as a permanent 10-millimeter path length. Because of the surface characteristics and material properties of the molded thermoplastic polymer, these structures are typically optimized as single-use consumables to mitigate optical surface degradation or chemical interactions associated with repeated exposure to chemical cleaning solvents. Geometrically, the internal fluid boundaries are defined by rigid, integrated walls, establishing an unalterable physical optical path length through the fluid sample and utilizing exogenous fluid dilution protocols when analyzing highly concentrated analytes. Volumetrically, the vertical depth and internal capacity of the fluid cavity utilize an elevated minimum fluid sample volume threshold, such as approximately 1500 microliters or greater, to ensure the fluid column height intersects the horizontal beam height axis of an instrument sample bay. Consequently, these macro-scale configurations lack a standalone, open-access internal chamber geometry optimized to passively isolate and contain a static, sub-microliter fluid volume within a standard laboratory cuvette-holder interface.

Alternative high-precision sub-micro volume analytical vessels utilize multi-material optical assemblies incorporating an integrated opaque masking body around a localized internal measurement cavity, as utilized in conventional sub-microvolume fluorometric analysis. These configurations typically feature a fluid channel fabricated from optical quartz substrates enclosed by a light-blocking mask and configured to receive an upper sealing element, such as a removable fluoropolymer stopper structure. Because the composite assembly requires precise positioning of the opaque mask relative to the internal optical chamber, the structural integration relies on aligned thermal fusing and precision machining boundaries. Consequently, these structures are typically arranged as permanent, reusable components, necessitating sequential chemical rinsing cycles between distinct sampling steps to mitigate analyte carryover. Geometrically, the internal fluid containment cavity establishes a fixed, predetermined physical optical path length through the fluid sample. Accordingly, the configuration lacks an adjustable or variable pathlength profile to accommodate highly concentrated fluid analytes without exogenous dilution. Volumetrically, the physical dimensions and structural orientation of the stoppered internal cavity utilize minimum fluid sample volume thresholds ranging from approximately 10 microliters to 160 microliters to fill the optical measurement path and avoid scattering along the upper fluid boundaries. Consequently, these sub-micro configurations lack a standalone, open-access internal chamber geometry optimized to passively isolate and contain a static, sub-microliter fluid volume within a standard fluorometer cuvette-holder interface.

In summary, the present disclosure provides a standalone, microvolume analytical vessel adapted for passive fluid containment and direct modular, drop-in integration into a standard sample receptacle of conventional spectroscopic instruments without requiring auxiliary external electronics or custom instrument housing arrays.

While specific embodiments have been described above, it is to be understood that the present disclosure is not limited to these precise structural, mechanical, or material configurations. Various modifications, alternative geometric profiles, alternative material selections, and alternative fluid delivery configurations may be resorted to by those skilled in the art without departing from the spirit and scope of the present disclosure as defined and limited solely by the appended claims.

What is claimed is:

1. A cuvette for spectrophotometric analysis comprising: an L-shaped body having a base and a lateral face made out of an opaque material or an optically transparent material with a light-masking layer dimensioned to fit within a spectrophotometer cuvette holder; an internal chamber defining an internal cavity open at a top surface of the lateral face for direct pipette loading, the internal cavity having an optical path length of 0.1 mm to 12.5 mm between two opposing surfaces; wherein the internal chamber is dimensioned with a cross-sectional dimension of 0.05 mm to 3 mm to draw and retain a sample fluid via capillary action and surface tension of the sample fluid; wherein the internal chamber is configured to align collinear along an optical axis of an incident light source; wherein the cuvette utilizes the internal cavity to retain a sample volume of at least 0.25 microliters for absorbance measurement.

2. The cuvette of claim 1, wherein the cuvette body is dimensioned to fit within a standard 12.5 mm×12.5 mm×45 mm spectrophotometer cuvette holder without requiring auxiliary adapter components.

3. The cuvette of claim 1, wherein the cuvette further comprises a second internal chamber positioned on the same lateral face of the L-shaped body as the internal chamber, and positioned to facilitate dual-loading of sample fluid for sequential absorbance measurements.

4. The cuvette of claim 1, further comprising a reversibly attachable housing piece configured to mate with the L-shaped body to provide structural support.

5. The cuvette of claim 1, wherein the internal cavity comprises a surface treatment selected from the group consisting of a hydrophobic treatment and a hydrophilic treatment applied to an internal surface of the internal chamber to modulate surface energy and enhance liquid retention within the optical path length.

6. The cuvette of claim 1, wherein the internal chamber features a pair of rims on opposite sides of the two opposing surfaces, and wherein a pair of light-transparent windows are disposed over the rims in parallel planes relative to each other and perpendicular to an incident light path.

7. The cuvette of claim 1, wherein the internal chamber is elevated above the base of the L-shaped body by one or more support beams extending from the lateral face, such that an area surrounding the internal chamber remains laterally unobstructed to permit direct submersion of the internal chamber into a sample fluid reservoir for passive capillary loading.

8. The cuvette of claim 1, wherein a portion of the lateral face of the L-shaped body surrounding the internal chamber is recessed or reduced in thickness to restrict the optical path length and mitigate optical signal attenuation at elevated analyte concentrations.

9. The cuvette of claim 1, wherein the cuvette body is composed of a material selected from the group consisting of glass, quartz, polymethyl methacrylate (PMMA), polystyrene, polycarbonate, cyclic olefin copolymer (COC), polypropylene (PP), polyethylene (PE), and polydimethylsiloxane (PDMS); and wherein the material is either intrinsically opaque or is a transparent material having a light-masking layer applied to an exterior surface thereof to attenuate stray light transmission.

10. The cuvette of claim 1, wherein the internal chamber is dimensioned with a cross-sectional dimension of 0.05 mm to 3 mm and the optical path length is 0.1 mm to 12.5 mm.

11. The cuvette of claim 1, wherein the internal chamber has a cross-sectional dimension configured to structurally constrain the sample fluid into a self-supporting liquid column via surface tension, such that a length of the self-supporting liquid column varies proportionally with the volume of the sample fluid introduced to provide a variable optical path length along the optical axis.

12. The cuvette of claim 1, wherein the internal chamber further comprises a geometric bubble trap positioned adjacent to the internal chamber, the geometric bubble trap comprising a localized channel widening configured to passively redirect and isolate air bubbles away from the optical path length during loading.

13. A cuvette for fluorometric spectroscopic analysis comprising: an opaque block featuring at least two intersecting chambers oriented orthogonally to one another, comprising an excitation channel and an emission channel configured to align along the optical axis of an incident light source and a fluorescence detector, respectively; wherein the intersection of the intersecting chambers defines an internal cavity dimensioned with a cross-sectional radius of 0.05 mm to 3 mm to draw and retain a sample fluid via capillary action and surface tension of the sample fluid; wherein a channel depth from an outer rim of each chamber to the nearest edge of the intersection, ranges from 0.1 mm to 6.25 mm; wherein the block is dimensioned to fit within a fluorometer cuvette holder.

14. The cuvette of claim 13, wherein at least one of the chambers features a non-circular cross-sectional geometry selected from the group consisting of a rectangular cross-section and an elliptical cross-section.

15. The cuvette of claim 13, further comprising an auxiliary analysis pathway intersecting the intersection of the orthogonal chambers at a non-orthogonal angle of 45 degrees, and wherein the opaque block features an angled exterior surface oriented perpendicular to an auxiliary optical detector, such that incident light scattered by a sample fluid retained at a channel intersection is directed toward an external optical sensor to facilitate nephelometric analysis.

16. The cuvette of claim 13, further comprising a second internal cavity positioned symmetrically on the other half of the cuvette, wherein the second internal cavity is geometrically substantially identical to the first internal cavity.

17. The cuvette of claim 13, further comprising a converging lens disposed within the emission channel to focus incident light or a collection lens disposed within the excitation channel of the opaque block at an opening of the excitation channel.

18. The cuvette of claim 13, wherein an external width of the opaque block is either widened to approximately 17.5 mm or reduced to approximately 5 mm to accommodate alternative spectroscopic instrument configurations.

19. A cuvette for spectrophotometric or fluorometric analysis comprising: a first mating body portion and a second mating body portion configured to join together to form a complete cuvette body; each of the first and second mating body portions including a respective chamber that collectively define an internal chamber aligned with an optical path of a spectrophotometer or fluorometer when joined; wherein each mating body portion includes coupling features selected from the group consisting of a magnetic engagement mechanism, a snap-fit mechanism, and a friction-fit interface; and alignment features selected from the group consisting of alignment pins and corresponding apertures configured to establish optical registration between the first and second mating body portions upon assembly; and sealing features selected from the group consisting of an elastomeric gasket and an adhesive sealant, applied to the respective body portions to ensure a leak-proof and optically aligned junction upon assembly; a removable insert plate positioned within an indented area between the first mating body portion and the second mating body portion, the insert plate defining an aperture aligned with the body portions; and a light-transmissive layer disposed on at least one face of the insert plate to inhibit fluid migration into adjacent components; wherein the assembled cuvette body is dimensioned to fit within a spectrophotometer cuvette holder.

20. The cuvette of claim 19, wherein at least one of the first or second mating body portions incorporates an integrated hinge-flip mechanism configured to permit selective folding and sealing of the internal chamber boundaries without complete separation of the mating body portions.
